(19) United States
(12) Patent Application Publication
(10) Pub. No.: US 2010/0303953 A1
(43) Pub. Date: Dec. 2, 2010

(54) SLOWLY FERMENTABLE SOLUBLE DIETARY FIBER

(75) Inventors: Bruce R. Hamaker, West Lafayette, IN (US); Devin J. Rose, Lincoln, NE (US); Ali Keshavarzian, Evanston, IL (US); Pinthip Rumpagaporn, West Lafayette, IN (US); Osvaldo H. Campanella, West Lafayette, IN (US)

Correspondence Address: HAYNES AND BOONE, LLP;IP Section, 2323 Victory Avenue, Suite 700, Dallas, TX, 75219, US

(73) Assignee: Purdue Research Foundation, West Lafayette, IN (US)

(21) Appl. No.: 12/791,802

(22) Filed: Jun. 1, 2010

Related U.S. Application Data
(60) Provisional application No. 61/182,381, filed on May 29, 2009.

(51) Int. Cl. A23L 1/308

(52) U.S. Cl. 426/2

(57) ABSTRACT

The embodiments described herein provide a method for improving bowel health by increasing short chain fatty acid concentration in the colon of a mammal including administering to the mammal a composition having from about 0.1 grams to about 50 grams of a treated bran product. After administration, the treated bran product results in an increased short chain fatty acid production during fermentation in the colon as compared to untreated bran fermented in the colon.

### CROSS-REFERENCE TO RELATED APPLICATION

This patent application is a non-provisional of U.S. Patent Application No. 61/182,381, filed on May 29, 2009, which is incorporated by reference herein in its entirety.

### FIELD OF THE INVENTION

Embodiments of the present invention relate generally to a method for improving bowel health by administering a treated bran or hydrolyzate product, in particular the product has about 50% to about 93% by weight arabinoxylans.

### BACKGROUND

It is clear that individuals on a normal Western diet do not consume enough dietary fiber. In the United States, adult men and women, on average, consume an inadequate 17.8 and 14.1 g/d, respectively (1). This is in comparison with recommendations of 38 and 25 g/d, respectively (2-3).

There are numerous adverse effects of inadequate dietary fiber intake. In addition to constipation, recent literature ties insufficient dietary fiber consumption with increased risk of colon cancer (4-5), type 2 diabetes (6-7), heart disease (8), obesity (9), and inflammatory bowel disease (10). Three of these diseases (i.e., cancer, diabetes, and heart disease) are among the top 10 leading causes of death in the United States (11).

The solubility of a dietary fiber can facilitate the inclusion of fiber into food and beverage products as soluble fiber can be more easily incorporated into food formulations without detrimental effects on sensory properties, while insoluble dietary fibers generally produce grittiness and reduced sensory profile.

From a nutritional standpoint, dietary fibers with a slow fermentation rate may be most desirable. A slow fermentation rate has two major benefits. First, slow fermentation minimizes bloating due to low initial production of gas by the gut microbiota; gases produced have time to be absorbed and exhaled before colonic distension occurs. Second, slow fermentation allows for high short chain fatty acid (“SCFA”) production by the gut microbiota in the distal colon. Slowly fermentable fiber prevents the build-up of toxic metabolites, such as phenols and ammonia, which accumulate due to bacterial fermentation of protein when fermentable carbohydrate is not available. Slowly fermentable fiber creates an environment that is less favourable for the development of colonic diseases such as colon cancer and ulcerative colitis.

Unfortunately, most dietary fibers available today are either rapidly fermenting or poorly fermenting. Rapidly fermenting soluble dietary fibers, such as pectin, fructooligosaccharides, and β-glucan, ferment rapidly in the cecum and proximal colon, leaving little carbohydrate substrate for bacteria in distal regions of the colon (12), while insoluble dietary fibers, such as cellulose and other intact cell wall polysaccharides, do not ferment substantially and contribute mainly to stool bulking and pass through the colon largely intact.

Thus, dietary fiber should be soluble to facilitate its use in foods and ferment slowly and completely. This advantageously provides benefits over existing dietary fibers because it is easier to incorporate into foods, and does not contribute to excessive bloating and induces high SCFA production in the distal colon for the prevention of colonic disease.

Cereal brans present an interesting source of dietary fiber because they can be obtained cheaply, contain high levels of dietary fiber, and their consumption has been associated with lower risk of disease (16). Unfortunately, cereal brans are generally poorly fermented (17), and thus not desirable dietary fibers for stimulating a healthy colonic production of SCFAs.

While pre-existing approaches for treating and preventing disease by consuming fiber products have been generally adequate, they have not been satisfactory in all respects, namely that the fiber products are either poorly fermented and do not induce substantial SCFA production in the distal colon, or result in excessive bloating and gas due to rapid fermentation in the proximal colon.

### BRIEF SUMMARY OF THE INVENTION

The embodiments described herein provide a method for improving bowel health by increasing short chain fatty acid concentration in the colon of a mammal including administering to the mammal a composition having from about 0.1 grams to about 50 grams of a treated bran product. After administration, the treated bran product results in an increased short chain fatty acid production during fermentation in the colon as compared to untreated bran fermented in the colon.

According to certain embodiments of the present invention shown in FIG. 1, the treated bran product is produced by a method that includes contacting a bran with a first alpha-amylase enzyme and a first protease enzyme sufficient to form an enzyme modified bran; deactivating the first alpha-amylase and protease enzymes; contacting the enzyme modified bran with an alkaline and hydrogen peroxide solution for a time sufficient to produce an alkali-soluble bran; isolating the alkali-soluble bran from the alkaline and hydrogen peroxide solution using ethanol precipitation; contacting the alkali-soluble bran with a second alpha-amylase enzyme and a second protease enzyme sufficient to form a treated bran; deactivating the second alpha-amylase and protease enzymes; and isolating the treated bran from the second alpha-amylase and protease enzymes using ethanol precipitation to form a treated bran product. According to certain embodiments, the bran is corn, wheat, rice, sorghum, or any combination thereof. In certain other embodiments, the bran is a cereal bran.

Certain other embodiments of the present invention provide that, after administration of the treated bran product, the carbohydrate content in the treated bran product is fermented more than untreated bran during fermentation. In still other embodiments, the carbohydrate content is reduced to less than 10% of the initial carbohydrate content during such fermentation.

Also according to certain embodiments of the present invention, the treated bran product is made from corn bran and, after administration, the treated corn bran product produces a lower amount of gas during the first four hours of fermentation as compared to treated rice bran and wheat bran, wherein the treated rice bran and wheat bran are treated in same manner as the treated corn bran. The treated corn bran product has a slow rate of fermentation and is a fermentable substrate in the distal colon. The treated corn bran product results in an increased short chain fatty acid production during fermentation in the colon as compared to treated rice bran and wheat bran. The treated corn bran product includes from about 50% to about 93% by weight arabinoxylans.

Certain other embodiments of the present invention, shown in FIG. 2, involve the treated bran product produced by a method involving contacting a bran with a first alpha-amylase enzyme and a first protease enzyme sufficient to form an enzyme modified bran; deactivating the first alpha-amylase and protease enzymes; contacting the enzyme modified bran with an alkaline and hydrogen peroxide solution for a time sufficient to produce an alkali-soluble bran; separating the alkali-soluble bran from the alkaline and hydrogen peroxide solution; and isolating the alkali-soluble bran using a first and a second precipitation step to produce a treated bran product, wherein the first ethanol precipitation step uses a first ethanol solution and the second ethanol precipitation step uses a second ethanol solution having an ethanol concentration higher than the first ethanol solution. According to certain embodiments, the bran is corn, wheat, rice, sorghum, or any combination thereof. Moreover, according to certain embodiments, the bran is corn and is referred to as “CAX.” Also according to certain embodiments of the present invention, the treated corn bran product, after administration, produces a low amount of gas during the first four hours of fermentation as compared to untreated rice bran and wheat bran. The treated corn bran product includes from about 50% to about 93% by weight arabinoxylans and has a degree of polymerization of about 4500.

Certain embodiments of the present invention provide a method for improving bowel health by increasing short chain fatty acid concentration in the colon of a mammal, in particular in the distal colon of a human, including administering to the mammal a composition having from about 0.1 grams to about 50 grams of a bran hydrolyzate product. After administration, the bran hydrolyzate product results in an increased short chain fatty acid production during fermentation in the colon, particularly in the distal colon, as compared to untreated bran fermented, alkali-soluble wheat bran, and alkali-soluble rice bran in the colon.

According to certain embodiments of the present invention, the bran hydrolyzate product is produced by a method including contacting a bran with a first alpha-amylase enzyme and a first protease enzyme sufficient to form an enzyme modified bran; deactivating the first alpha-amylase and protease enzymes; contacting the enzyme modified bran with an alkaline and hydrogen peroxide solution for a time sufficient to produce an alkali-soluble bran; separating the alkali-soluble bran from the alkaline and hydrogen peroxide solution; isolating the alkali-soluble bran using a first and a second precipitation step to produce an ethanol precipitated alkali-soluble bran, wherein the first ethanol precipitation step uses a first ethanol solution and the second ethanol precipitation step uses a second ethanol solution having an ethanol concentration higher than the first ethanol solution; contacting the ethanol precipitated alkali-soluble bran with an endoxylanase sufficient to form a bran hydrolyzate; deactivating the endoxylanase; and isolating the bran hydrolyzate using the first and second precipitation step to produce a bran hydrolyzate product. According to certain embodiments, the bran is corn, wheat, rice, sorghum, or any combination thereof.

Another embodiment of the present invention provides that the bran hydrolyzate product is made from corn bran and, after administration, the corn bran hydrolyzate product produces a low amount of gas during the first four hours of fermentation as compared to untreated rice bran and wheat bran and an increased short chain fatty acid production during fermentation in the colon as compared to untreated bran fermented in the colon. Moreover, in certain embodiments the corn bran hydrolyzate product produces a low amount of gas during the first four hours of fermentation as compared to rice bran hydrolyzate product processed by the same method as the corn bran hydrolyzate product. The corn bran hydrolyzate product includes from about 50% to about 93% by weight arabinoxylans.

A certain embodiment of the present invention includes a bran hydrolyzate product is made from wheat bran and, after administration, the wheat bran hydrolyzate product produces a low amount of gas during the first four hours of fermentation as compared to untreated wheat bran. Moreover, in certain embodiments the wheat bran hydrolyzate product produces a low amount of gas during the first four hours of fermentation as compared to a corn bran hydrolyzate product and a rice bran hydrolyzate product, which have been processed by the same method as the wheat bran hydrolyzate product. The wheat bran hydrolyzate product includes from about 50% to about 93% by weight arabinoxylans.

In still another embodiment, the corn bran hydrolyzate product has a lower viscosity and a lighter color as compared to the wheat bran hydrolyzate product.

Another embodiment provides for a food or beverage product made from the methods described herein. In yet another embodiment the present invention provides a soluble fiber supplement for food, beverages, or feed made from the methods described herein.

### BRIEF DESCRIPTION OF THE DRAWINGS

FIG. 1 is a schematic illustration of the treatment and precipitation steps in accordance with an illustrative embodiment of the invention to produce a treated bran product including two enzymatic treatment steps using alpha-amylase and neutral protease enzymes and an alkaline-hydrogen peroxide treatment.

FIG. 2 is a schematic illustration of the treatment and precipitation steps similar to FIG. 1 but using only one enzymatic treatment with alpha-amylase and neutral protease enzymes and a graded ethanol precipitation step to produce a treated bran product (“CAX”).

FIG. 3 is a schematic illustration of the treatment and precipitation steps similar to FIGS. 1 and 2 but using two different enzymatic treatment steps and two graded ethanol precipitation steps processing method in accordance with an illustrative embodiment to produce a hydrolyzate product.

FIG. 4 is graph showing short chain fatty acid (SCFA) production during in vitro fecal fermentation of starting material (SM) and alkali-soluble material (AS) composed of either corn (maize) bran (MB), rice bran (RB), or wheat bran (WB). Blank has been subtracted from the data in FIG. 4; error bars show standard error; n=2.

FIG. 5 is a graph showing residual carbohydrate (sum of anhydrous neutral sugars and uronic acids at t=0 h) during in vitro fecal fermentation of starting material (SM) and alkali-soluble material (AS) composed of either corn (maize) bran (MB), rice bran (RB), or wheat bran (WB). Blank has been subtracted from the data in FIG. 5; error bars show standard error; n=2.

FIG. 6 is a graph showing changes in arabinose/xylose ratio during in vitro fecal fermentation of starting material (SM) and alkali-soluble material (AS) composed of either corn (maize) bran (MB), rice bran (RB), or wheat bran (WB). For the AS-RB sample at t=24 h, the arabinose/xylose ratio was 0, meaning that there was no arabinose, but some xylose detected in the fermentation. Medium error bars show standard error; n=2.

FIG. 7 is a graph illustrating size-exclusion chromatography elution profiles of alkali-soluble corn (AS-MB), rice (AS-RB), and wheat (AS-WB) bran fractions. Peak retention times of pullulan standards of molecular weight 78.8×10⁴, 21.2×10⁴, 4.73×10⁴, 1.18×10⁴, and 0.74×10⁴ are marked with triangles along the x-axis (left to right) and the refractive index (RI) is shown on the y-axis.

FIG. 8 shows the anomeric region of ¹H-NMR spectra of alkali-soluble corn (maize) (AS-MB), rice (AS-RB), and wheat (AS-WB) bran fractions.

FIG. 9 is a graph of gas produced during fermentation (μl/mg carbohydrate) of water-soluble rice (WS-RB) and wheat (WS-WB) bran fractions and alkali-soluble rice bran (AS-RB), wheat bran (AS-WB), and corn (AS-CB). Blank has been subtracted from the data; error bars show standard error (upper error bar only); some error bars are too small to see; n=2.

FIG. 10 is a graph showing the viscosity and shear rate of mixtures prepared in accordance with an embodiment of the invention having 5% or 10% of CAX or corn bran hydrolyzate product with the balance deionized water.

### DETAILED DESCRIPTION

Embodiments of the present invention described herein provide a method for improving bowel health by increasing short chain fatty acid concentration in the colon of a mammal including administering to the mammal of a treated bran product or a hydrolyzate bran product and, after administration, the treated or hydrolyzate bran product results in an increased SCFA production during fermentation in the colon as compared to untreated bran fermented in the colon. Certain embodiments of the present invention provide a low initial product of gas during fermentation, which minimizes bloating and contributes to an improved amount of SCFA in the distal regions of the colon.

Fiber fermentation in the colon produces SCFAs (e.g., acetic, propionic, and butyric acids) that contribute to colon health by increasing blood flow, improving mineral and water absorption by maintenance of low luminal pH. Moreover, SCFAs are the main products of anaerobic dietary bran fermentation, and exhibit numerous trophic effects on the colonic environment. Because SCFAs reduce colonic pH, they inhibit the growth of opportunistic, pathogenic bacteria (33), decrease the activity of co-carcinogenic enzymes such as glucuronidases, glycosidases, and 7α-hydroxylases (34-35), increase mineral absorption (36), and reduce ammonia absorption by maintaining ammonium in its less diffusible, ionic form (37).

SCFAs themselves also have a number of physiological effects. Acetate and propionate are readily absorbed by diffusion, and, as the major anions in the colon, absorption is facilitated by anion exchange with sodium and potassium (38). Once absorbed, acetate and propionate are taken up by the liver or peripheral tissues. Acetate can be used for the synthesis of long chain fatty acids, glutamine, glutamate, and betahydroxybutyrate (17), and acetate is also a major substrate for cholesterol synthesis (39). Indeed, when subjects were fed 25 g/d of lactulose, a highly fermentable, highly acetogenic synthetic disaccharide, significant increases in serum total, low-density-lipoprotein cholesterol, and apolipoprotein B concentrations were observed (40). Propionate appears to counter the hypercholesterolemic effects of acetate (41). In rats, propionate was shown to decrease cholesterol synthesis (42-43). Propionate is also a substrate for hepatic gluconeogenesis (39), and therefore may influence glucose metabolism and postprandial blood glucose levels. Butyrate is utilized mainly by colonic epithelial cells for energy (17). Butyrate also influences cell differentiation and proliferation (44), and has therefore been implicated in the prevention of colon cancer (45). In vitro studies have also shown that butyrate suppresses the inflammatory response by inhibiting NF-κB activation (46), and patients treated with butyrate enemas have shown decreased inflammation related to a reduction in the number of macrophages positive for NF-κB (47).

Along with SCFAs, fiber fermentation by the colonic microbiota in the colon produces gas as an additional by-product. Depending on the source of dietary fiber, gas may be produced rapidly or over a sustained period of time. Large amounts of gas production during the first four hours of fermentation often cause the particularly troublesome problems of bloating, pain, and abdominal distension. Conversely, sustained gas production, such as over a 12-24 hour period, is not associated with bloating because the gases have time to be absorbed and exhaled before colonic distension occurs.

The embodiments described herein provide a method for improving bowel health by increasing short chain fatty acid concentration in the colon of a mammal including administering to the mammal a composition having from about 0.1 grams to about 50 grams, from about 0.1 to about 40 grams, from about 0.1 grams to about 30 grams, from about 0.1 grams to about 20 grams, from about 0.1 to about 10 grams, and from about 0.1 to about 5 grams of a treated bran product. After administration, the treated bran product results in an increased short chain fatty acid production during fermentation in the colon as compared to untreated bran fermented in the colon.

Bran, as used herein, includes the edible outer layer of an edible cereal grain, such as, but not limited to corn, wheat, rice sorghum, or any combination thereof. The bran is a cereal bran. Corn bran is described herein as maize bran and is abbreviated as “MB” or indicated by the capital letter “C.”

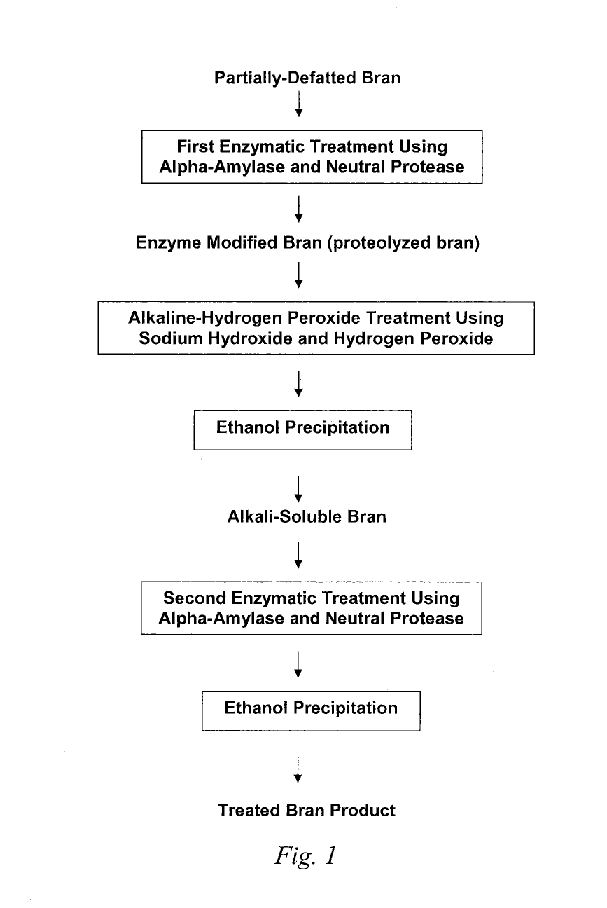

An untreated bran is bran that has not been processed according to the methods described herein and as illustrated by FIGS. 1-3, e.g., untreated bran is the edible outer layer of an edible cereal grain.

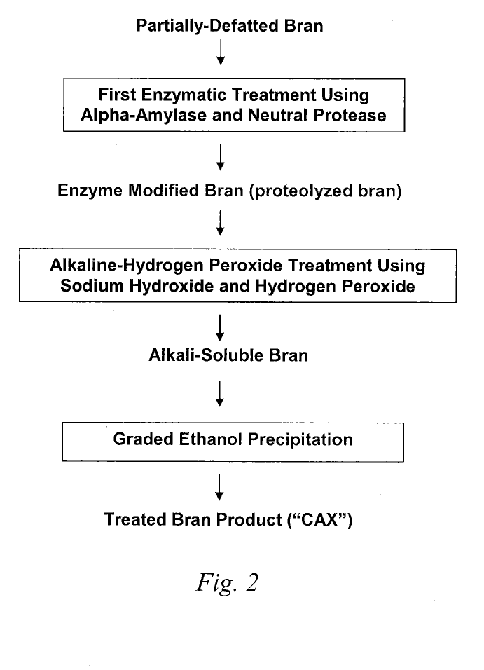

A treated bran is bran that has been processed by the methods described herein and as illustrated by FIGS. 1-2. A treated bran is a water soluble bran. In particular, the final and administered product is referred to as a treated bran product or bran hydrolyzate product.

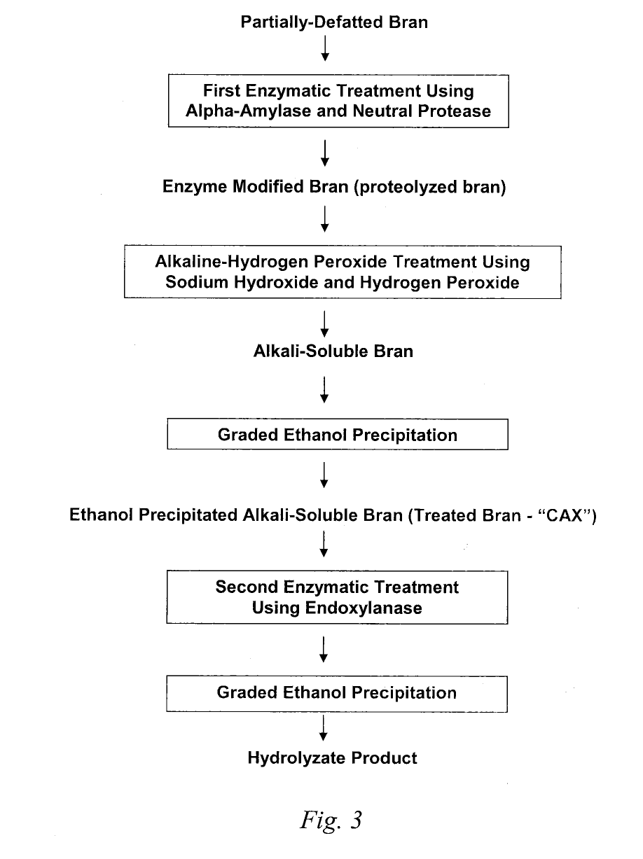

A bran hydrolyzate product is the final and administered product processed by the methods described herein and as illustrated by FIG. 3. The bran hydrolyzate product is a water soluble bran.

According to certain embodiments of the present invention as illustrated in FIG. 1, the treated bran product is processed by a method that includes enzymatic hydrolysis before and after an alkaline hydrogen peroxide treatment. In particular the treated bran is finely ground to about 0.5 mm and partially defatted using conventional procedures, such as, but not limited to contact the finely ground fiber with hexane. The partially defatted bran is then suspended in an amount of about 1:9 w/w. The pH of the water and bran mixture is adjusted for a first enzymatic treatment including contacting the bran with a first alpha-amylase enzyme and a first neutral protease enzyme, for example, to a pH of 7.0, by the dropwise addition of sodium hydroxide or hydrochloric acid. Under constant stirring, the bran and water mixture is boiled and then cooled to 95° C. and a first alpha-amylase enzyme is added thereto. The first alpha-amylase enzyme is a heat stable alpha-amylase such as, but not limited to, commercially available as A3403 from Sigma-Aldrich Corp; other similar enzymes can be used. The starch in the bran is hydrolyzed by the alpha-amylase at a temperature between 90-95° C. for 30 minutes and then cooled to 50° C. using conventional means such as, but not limited to an ice bath. The pH of the mixture is then adjusted to a suitable pH for a first protease enzyme, such as, but not limited to 6.0 by the dropwise addition of sodium hydroxide or hydrochloric acid. The first protease enzyme is a neutral protease enzyme commercially available as Sigma P1236 protease from Bacillus amyloliquefaciens from Sigma-Aldrich Corp; other similar enzymes can be used. The first protease enzyme is added to the alpha-amylase, bran, and water mixture and is kept at a temperature of 50° C. for 4 hours. The mixture is then boiled to deactivate the enzymes, and cooled to a temperature of less than 50° C., and the pH is adjusted to 7.0 by the dropwise addition of sodium hydroxide. The enzyme modified bran is then separated from the slurry such as, but not limited to, centrifuging the slurry at 10,000 g for 10 min. The enzyme modified bran is then washed with water, dried, and ground using conventional methods. The enzyme modified bran is a destarched and proteolyzed enzyme modified bran.

The enzyme modified bran is contacted with alkaline and hydrogen peroxide solution for a time sufficient to produce an alkali-soluble bran. In particular, the enzyme modified bran is first suspended in 1 M sodium hydroxide and 30% hydrogen peroxide is then slowly added to the mixture under constant mixing at 60° C. The quantities of the bran, sodium hydroxide, and 30% hydrogen peroxide varies depending on the quantity of bran being treated, for example and not limitation, 50 grams of enzyme modified bran is suspended in 1 L of sodium hydroxide and 42 ml of 30% hydrogen peroxide is added thereto. The enzyme modified bran and alkaline-hydrogen peroxide mixture is stirred for about four hours and yields alkali-soluble bran, which is then separated using conventional methods such as, but not limited to, centrifuging at 10,000 g for 10 minutes.

The alkali-soluble bran is isolated using conventional methods such as, but not limited to ethanol precipitation. In particular, ethanol is added to the alkali-soluble corn bran and held overnight at 4° C. to liberate the ferulic acid, which is siphoned off with the ethanol. The precipitated alkali-soluble corn bran is then washed with 80% ethanol, anhydrous ethanol, and acetone. The resulting alkali-soluble corn bran is dried, followed by the addition of ethanol to the supernatant. The alkali-soluble bran is then dried to remove the solvent and then dried again to purify the alkali-soluble corn bran using conventional drying methods, such as, but not limited to, air drying or drying in an oven.

The alkali-soluble bran undergoes a second enzymatic treatment as shown in FIG. 1. In particular, the alkali-soluble bran is suspended in an amount of about 1:9 w/w. The pH of the water and alkali-soluble bran mixture is adjusted for a second enzymatic treatment including contacting the bran with a second alpha-amylase enzyme and a second neutral protease enzyme, for example, to a pH of 7.0, by the dropwise addition of sodium hydroxide or hydrochloric acid. Under constant stirring, the bran and water mixture is boiled and then cooled to 95° C. and a second alpha-amylase enzyme is added thereto. The second alpha-amylase enzyme is a heat stable alpha-amylase such as, but not limited to, commercially available as A3403 from Sigma-Aldrich Corp; other similar enzymes can be used. The starch in the bran is hydrolyzed by the alpha-amylase at a temperature between 90-95° C. for 30 minutes and then cooled to 50° C. using conventional means such as, but not limited to an ice bath. The pH of the mixture is then adjusted to a suitable pH for a second protease enzyme, such as, but not limited to 6.0 by the dropwise addition of sodium hydroxide or hydrochloric acid. The second protease enzyme is a neutral protease enzyme commercially available as Sigma P1236 protease from Bacillus amyloliquefaciens from Sigma-Aldrich Corp; other similar enzymes can be used. The second protease enzyme is added to the alpha-amylase, bran, and water mixture and is kept at a temperature of 50° C. for 4 hours. The mixture is then boiled to deactivate the enzymes, and cooled to a temperature of less than 50° C., and the pH is adjusted to 7.0 by the dropwise addition of sodium hydroxide. The bran is then separated from the slurry such as, but not limited to, centrifuging the slurry at 10,000 g for 10 min. The bran is then isolated using conventional methods including, but not limited to, ethanol precipitation, washing with water, and drying. The final product is a treated bran product that, after administration to a mammal, results in an increased short chain fatty acid production during fermentation in the colon as compared to untreated bran fermented in the colon.

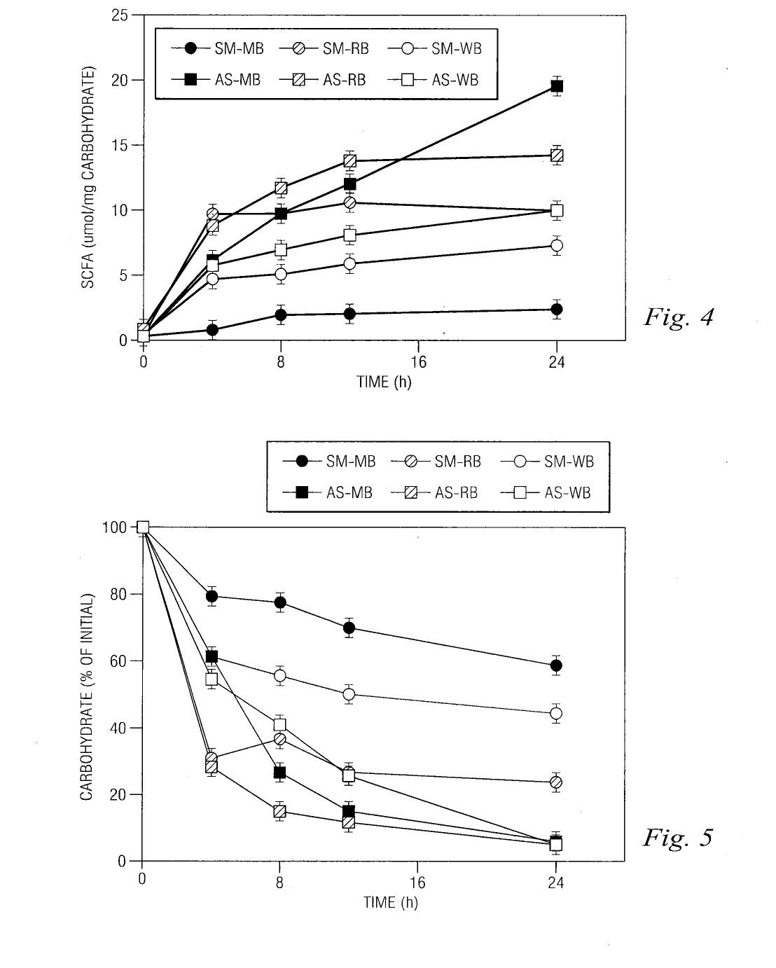

The combination of enzymatic and alkaline-hydrogen peroxide treatments pursuant to the method described above and shown in FIG. 1 results in a treated bran product having no detectable starch and with over 70% less protein than untreated bran. In particular, after administration, the treated bran product made from corn processed by the method according to FIG. 1 resulted in a surprising fecal fermentation profile having a linear shaped SCFA production over a twenty-four hour fermentation period as shown in FIG. 4. The linear shaped SCFA production establishes that the treated corn bran product has a slow fermentation rate as compared to untreated corn bran, treated wheat bran product, and treated rice bran product. The slow and complete fermentation profile of the treated corn bran product is unexpected because soluble fibers generally ferment rapidly and with no fermentable substrate available to the distal colon. Since the SCFA production continues to increase over the last twelve hours of fermentation, there is fermentable substrate available to the bacteria in the distal colon. This is surprising because soluble fibers generally ferment rapidly and with no fermentable substrate available to the distal colon. In light of this, the treated corn bran product is a beneficial prebiotic for the distal colon as it provides a fermentable substrate in the distal colon.

Also beneficially, the treated corn bran results in surprisingly increased SCFA production during fermentation in the colon as compared to treated rice and wheat brans (e.g., the treated rice and wheat brans were treated using the same method as the treated corn bran).

Moreover, the treated corn bran product produces a lower amount of gas during the first four hours of fermentation as compared to treated rice bran and wheat bran, wherein the treated rice bran and wheat bran are treated in same manner as the treated corn bran. In certain other embodiments, the treated corn bran product produces a lower amount of gas during the first four hours of fermentation as compared to untreated soluble fibers.

The fermentation profile of the treated corn bran product indicates that the treated corn bran is highly fermentable and is slower to ferment as compared to similarly treated rice and wheat brans. The treated corn bran product includes from about 73% to about 93% by weight arabinoxylans

FIG. 5 indicates that the amount of carbohydrates in the treated bran products (corn, wheat, and rice) were reduced substantially during fermentation. Indeed, these results are surprising in that the fermentation of carbohydrates was almost complete in that less than 10% of the initial carbohydrate remained in the treated brans (corn, wheat, and rice) after twenty-four hours of fermentation. In comparison, the untreated rice bran had over 20% of the initial carbohydrates after twenty-four hours of fermentation and the untreated wheat and rice were even higher.

According to an embodiment of the invention, the bran is processed by the method shown in FIG. 2. In particular, as compared to the method of bran processing described above and shown in FIG. 1, this method shown in FIG. 2 does not include a second enzymatic treatment and includes a graded ethanol precipitation. The method of processing bran shown in FIG. 2 includes, as described above, contacting a bran with a first alpha-amylase enzyme and a first protease enzyme sufficient to form an enzyme modified bran; deactivating the first alpha-amylase and protease enzymes; contacting the enzyme modified bran with an alkaline and hydrogen peroxide solution for a time sufficient to produce an alkali-soluble bran; and separating the alkali-soluble bran from the alkaline and hydrogen peroxide solution.

Unlike the method shown in FIG. 1, the alkali-soluble bran is isolated using a first and a second precipitation step to produce a treated bran product, wherein the first ethanol precipitation step uses a first ethanol solution and the second ethanol precipitation step uses a second ethanol solution having an ethanol concentration higher than the first ethanol solution. The isolation method is referred to herein as a graded ethanol precipitation procedure, wherein ethanol was added to 40% total volume and the precipitate was discarded, and ethanol was added further to 60% and the precipitate in this fraction was collected.

In particular, the alkali-soluble bran is rehydrated 3% w/w water. Then 95% ethanol is added to the water and alkali-soluble bran mixture in an amount sufficient to achieve a concentration of 40% ethanol under continuous stirring for 30 minutes and kept in a refrigerator at 4° C. overnight. The 40% ethanol, bran, and water mixture is then centrifuged for thirty minutes at 6° C., which provides a precipitate that is insoluble in 40% ethanol and a supernatant. Ethanol 95% is added to the supernatant to obtain a concentration of 60% ethanol by volume under continuous stirring for 30 minutes and is refrigerated overnight. The 60% ethanol mixture is then centrifuged at 10000×g for thirty minutes at 6° C. to yield a supernatant, which is discarded, and a precipitate that is insoluble in 60% ethanol. The first ethanol solution has a concentration of 40%, 50%, or 60% by volume ethanol depending on the bran. The second ethanol solution has a concentration higher than the first ethanol solution and has a concentration of 60%, 70%, 80%, or 90% by volume. The ethanol is removed by conventional methods, such as, but not limited to air drying to yield a treated bran product, which is an ethanol precipitated alkali-soluble bran.

According to certain embodiments described above and shown in FIG. 2, the treated bran product is made from corn bran and is referred to as “CAX.” The treated corn bran product, after administration to a mammal according to the methods above, produces a low amount of gas during the first four hours of fermentation as compared to untreated rice bran and wheat bran. A low amount of gas is e.g. low initial gas production is gas production less than 90 μl/mg of carbohydrate over the first four hours of fermentation. The treated corn bran product includes from about 50% to about 93% by weight arabinoxylans and has a degree of polymerization of about 4500.

Certain embodiments of the present invention provide a method for improving bowel health by increasing short chain fatty acid concentration in the colon of a mammal including administering to the mammal a composition having from about 0.1 grams to about 50 grams, from about 0.1 to about 40 grams, from about 0.1 grams to about 30 grams, from about 0.1 grams to about 20 grams, from about 0.1 to about 10 grams, and from about 0.1 to about 5 grams of a bran hydrolyzate product are shown in FIG. 3. After administration, the bran hydrolyzate product results in an increased short chain fatty acid production during fermentation in the colon as compared to untreated bran fermented in the colon.

According to certain embodiments of the present invention, the bran hydrolyzate product is produced by a method similar to the methods described in FIG. 2, however, the bran hydrolyzate product undergoes a second enzymatic treatment using an endoxylanase and a second graded ethanol precipitation. In particular, the method of making a bran hydrolyzate product includes contacting a bran with a first alpha-amylase enzyme and a first protease enzyme sufficient to form an enzyme modified bran; deactivating the first alpha-amylase and protease enzymes; contacting the enzyme modified bran with an alkaline and hydrogen peroxide solution for a time sufficient to produce an alkali-soluble bran; separating the alkali-soluble bran from the alkaline and hydrogen peroxide solution; and isolating the alkali-soluble bran using a first and a second precipitation step to produce an ethanol precipitated alkali-soluble bran, wherein the first ethanol precipitation step uses a first ethanol solution and the second ethanol precipitation step uses a second ethanol solution having an ethanol concentration higher than the first ethanol solution as described above to yield an ethanol precipitated alkali-soluble bran. In particular, the alkali-soluble bran was isolated using a graded ethanol precipitation step to produce an 40-60% ethanol precipitated alkali-soluble bran, wherein ethanol was added to 40% total volume and the precipitate was discarded, and ethanol was added further to 60% and the precipitate in this fraction was collected to yield ethanol precipitated alkali-soluble bran (CAX).

According to the method shown in FIG. 3, the ethanol precipitated alkali-soluble bran is contacted with an endoxylanase sufficient to form a bran hydrolyzate; deactivating the endoxylanase; and isolating the bran hydrolyzate using the first and second precipitation step to produce a bran hydrolyzate product. In particular, twenty-five grams of ethanol precipitated alkali-soluble bran is suspended in 1,250 ml of 25 mM sodium acetate buffer having a pH of about 5.0. Then 12.5 ml of an endoxylanase an enzyme commercially available as Multifect® CX XL having an activity of 445×AU/ml from Genencor is added to the suspension, which is incubated in a shaking incubator at 55° C. for 26 hours. Other enzymes similar to endoxylanase can be used. The enzyme suspension is then boiled for 30 minutes to inactivate the enzyme and centrifuged at 8000×g for thirty minutes. The small amount of precipitate is discarded to yield a hydrolyzate suspended in the supernatant. The supernatant is then dried in a freeze drier for 2 days at −60° C. to yield a hydrolyzate fraction.

After the endoxylanase treatment, the bran hydrolyzate is isolated using the first and second precipitation step to produce a bran hydrolyzate product. In particular, the bran hydrolyzate fraction underwent a graded ethanol precipitation which involves rehydrating 10 grams of the hydrolyzate fraction 3% w/w water. Then 95% ethanol is added in an amount to achieve 40% concentration of ethanol to the water and hydrolyzate mixture under continuous stirring for 30 minutes and kept in a refrigerator at 4° C. overnight. The mixture is then centrifuged for thirty minutes at 6° C., which provides a precipitate that is insoluble in 40% ethanol and a supernatant. The precipitate is discarded. Ethanol 95% is added to the supernatant to obtain a concentration of 60% ethanol by volume under continuous stirring for 30 minutes and is refrigerated overnight. The 60% ethanol mixture is then centrifuged at 10000×g for thirty minutes at 6° C. to yield a supernatant and precipitate that is insoluble in 60% ethanol. The ethanol is removed from the precipitate according to conventional methods, such as, drying to yield a bran hydrolyzate product that, after administration to a mammal, the bran hydrolyzate product results in an increased short chain fatty acid production during fermentation in the colon as compared to untreated bran fermented in the colon.

An embodiment of the invention provides that the bran hydrolyzate product is made from corn bran and, after administration, the corn bran hydrolyzate product produces a low amount of gas during the first four hours of fermentation as compared to untreated rice bran and wheat bran. The corn bran hydrolyzate product includes from about 50% to about 93% by weight arabinoxylans and has a degree of polymerization around 450.

A certain embodiment of the present invention includes a bran hydrolyzate product is made from wheat bran and, after administration, the wheat bran hydrolyzate product produces a low amount of gas during the first four hours of fermentation as compared to untreated wheat bran. The wheat bran hydrolyzate product includes from about 50% to about 93% by weight arabinoxylans.

The corn bran hydrolyzate has improved viscosity and characteristics as compared to a wheat bran hydrolyzate. For example, the corn bran hydrolyzate has a lower viscosity and a lighter color as compared to the wheat bran hydrolyzate product.

The present invention provides methods of treating and preventing disorders, disease conditions, particularly diseases of the colon, in a mammal and particularly in a human, by oral administration of a therapeutically-effective amount of a composition including a treated bran product or bran hydrolyzate product to an individual in need of treatment or prophylaxis. The result of treatment can be partially or completely alleviating, inhibiting, preventing, ameliorating and/or relieving the disorder, condition or one or more symptoms thereof. Administration is by oral ingestion. An individual in need of treatment or prophylaxis includes those who have been diagnosed to have a given disorder or condition and to those who are suspected, for example, as a consequence of the display of certain symptoms, of having such disorders or conditions.

References cited herein are incorporated by reference herein in their entirety to indicate the state of the art as of their publication or filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

The following examples are provided for illustration and not limitation.

### Example 1

The tested samples consisted of finely ground corn bran from Bunge Milling Inc. in St. Louis, Mo., and heat-stabilized rice bran and wheat bran were obtained from a local market. Rice bran and wheat bran were finely ground in a cyclone mill to pass through a 0.8 mm screen. Bran was partially defatted with two volumes of hexane using a bran:hexane ratio of 1:7 weight/volume for 30 min in an Erlenmeyer flask. After stirring, the bran was allowed to settle for about 5 to 10 minutes and the hexane was decanted through a vacuum flask, which collected the bran on Whatman No. 2 filter paper. The bran was allowed to air dry.

Bran was suspended in water in an amount of 1:9 w/w bran to water, and the pH was adjusted to 7.0. Under constant stirring, the mixture was boiled, and then cooled to 95° C. and 4 ml of heat stable α-amylase, which is commercially available from Sigma-Aldrich Corp., St. Louis, Mo., was added. The starch was hydrolyzed at about 90 to 95° C. for 30 min, and then the mixture was cooled in an ice bath to 50° C. The pH was adjusted to 6.0, and 5 ml of neutral protease, which is commercially available as Sigma P1236 protease from Bacillus amyloliquefaciens from Sigma-Aldrich Corp., St. Louis, Mo., were added. Protein was hydrolyzed at 50° C. for 4 h, and then the mixture was brought to a boil to inactivate enzymes, cooled in an ice bath, and the pH adjusted to 7.0. The slurry was centrifuged at 10,000 g for 10 minutes. The residue was washed 3 times with water, dried in a forced draft oven at 40° C. for 48 hours, ground in a cyclone mill, and passed through a 0.8 mm screen to yield enzyme modified bran fiber. These steps produced a destarched and proteolyzed enzyme modified bran.

The enzyme modified bran then underwent an alkaline-hydrogen peroxide method (23-24), with modifications. Fifty grams of the enzyme-treated bran from above were suspended in 1 L of 1 M sodium hydroxide. Under constant mixing at 60° C., 42 ml of 30% hydrogen peroxide was slowly added to the mixture, which was stirred for a total of 4 h, and then centrifuged (10,000 g for 10 min), followed by an ethanol precipitation involving the addition of 3 volumes of 95% ethanol to the supernatant. The mixture was held overnight at 4° C., and then the aqueous ethanol portion, containing the liberated ferulic acid, was siphoned off, discarded, and yield a precipitated material.

The alkali-soluble bran underwent a second enzymatic treatment involving suspending the alkali-soluble bran in water in an amount of 1:9 w/w bran to water, and the pH was adjusted to 7.0. Under constant stirring, the mixture was boiled, and then cooled to 95° C. and 4 ml of heat stable α-amylase, which is commercially available from Sigma-Aldrich Corp., St. Louis, Mo., was added. The starch was hydrolyzed at about 90 to 95° C. for 30 min, and then the mixture was cooled in an ice bath to 50° C. The pH was adjusted to 6.0, and 5 ml of neutral protease, which is commercially available as Sigma P1236 protease from Bacillus amyloliquefaciens from Sigma-Aldrich Corp., St. Louis, Mo., were added. Protein was hydrolyzed at 50° C. for 4 h, and then the mixture was brought to a boil to inactivate enzymes, cooled in an ice bath, and the pH adjusted to 7.0. The slurry was centrifuged at 10,000 g for 10 minutes. The residue was washed 3 times with water, dried in a forced draft oven at 40° C. for 48 hours, ground in a cyclone mill, and passed through a 0.8 mm screen to yield enzyme treated bran fiber.

The precipitated material was washed with 80% ethanol, 95% ethanol, and acetone. The resulting powder was air dried until no solvent could be detected by odor, and then further dried in an oven at 40° C. for 24 h.

In vitro digestion is a simulated upper gastrointestinal digestion, i.e., mouth, stomach, and small intestine, which was carried out by a method described in Lebet et al. (25), except pancreatin was suspended in phosphate buffer (20 mM pH 6.9, containing 10 mM calcium chloride) instead of water, and the concentrations of pepsin and pancreatin were increased by factors of 10 to enhance breakdown of digestible components. In particular, the in vitro digestion was performed when six g of sample were suspended in 42 ml of phosphate buffer (20 mM, pH 6.9, containing 10 mM sodium chloride). After temperature equilibration at 37° C. for about 10 to 20 min, 1 ml of salivary α-amylase (28.4 U/ml in 1 mM calcium chloride) was added, and the mixture shaken using LabLine, which is commercially available form EnvironShaker, Melrose Park, Ill., at 150 rpm and 37° C. for 15 min. The pH was adjusted to 2.0±0.1 with 6 N HCl, 1 ml of pepsin (51 U/ml in 15 mM HCl) was added, and the mixture shaken at 150 rpm and 37° C. for 30 min. The pH was adjusted to 6.9±0.1 with 6 N sodium hydroxide, 1 ml of pancreatin (5 mg/ml in phosphate buffer from above) was added, and the mixture shaken at 150 rpm and 37° C. for 90 min. Samples that had not been previously cooked (i.e., the raw bran starting materials) were submerged in boiling water for 20 min to facilitate digestion prior to salivary α-amylase treatment. Following digestion, the suspensions were dialyzed using a membrane, which is commercially available as Spectra/Por 3 from Spectrum Labs, Rancho Dominguez, Calif., against distilled water for 24 h with 3 changes of distilled water, and then freeze-dried using a freeze drier, which is commercially available from VirTis, Gardiner, N.Y.).

In vitro fermentation is simulated lower gastrointestinal fermentation, i.e., fermentation in the colon, which was carried out by a batch fecal fermentation method described in Lebet et al. (26), with some modifications to estimate the behavior of each fiber fraction in the colon. A sufficient sample such that each tube contained 50 mg of carbohydrate (neutral sugars and uronic acids) was weighed into each of 5 serum tubes for each replicate (i.e., one tube per replicate for each sampling period: 0, 4, 8, 12, and 24 h). Fermentations were carried out in duplicate. Anaerobic carbonate-phosphate buffer was prepared pursuant to the methods described in Durand et al., 1988, and then sterilized by autoclaving for 20 min at 121° C. Immediately following autoclaving, 0.25 mg/L of cysteine hydrochloride was added as a reducing agent, and carbon dioxide was bubbled through the buffer. During use, a constant stream of carbon dioxide was bubbled through the buffer to maintain anaerobiosis. Four ml of this buffer were added, along with 100 μl of Oxyrase, which is commercially available as Oxyrase for Broth from Oxyrase, Inc., in Mansfield, Ohio, to each tube. The Oxyrase was added to scavenge any residual oxygen, and the tubes were sealed anaerobically (by flushing headspace with carbon dioxide) with a rubber stopper and metal crimp cap, and placed at 4° C. overnight to hydrate.

The next morning, feces were collected from 3 healthy volunteers consuming unspecified and varied diets and who had not taken antibiotics in the last 3 months. Once feces were collected, they were kept on ice and tightly sealed in plastic with air expelled and used within 2 hours. The feces were combined and homogenized with 3 parts sterile anaerobic carbonate-phosphate buffer (prepared and maintained as described above) and then filtered through 4 layers of cheesecloth. Tubes were opened and 1 ml of filtrate was used to inoculate each tube under constant carbon dioxide flushing. The tubes were then re-sealed and incubated at 37° C. with gentle shaking. At pre-determined time intervals (0, 4, 8, 12, or 24 h), the tubes were removed from the water bath, and total gas volume was measured by insetring a needle attached to a graduated syringe through the rubber stopper. The tubes were then opened, and microbial activity was halted by the addition of 0.4 ml of 2.75 mg/ml copper sulfate (containing 12.5 mg/ml of myo-inositol, as an internal standard for residual carbohydrate analysis). The pH was recorded, and a 0.4 ml aliquot was combined with 0.1 ml of 5% phosphoric acid (containing 50 mM 4-methyl valeric acid, as an internal standard for SCFA analysis), mixed with a vortex mixer, and frozen (−40° C.) for SCFA quantification. The remainder of the reaction mixture was also frozen and then freeze-dried for monosaccharide analysis.

Moisture content of samples was determined by loss in weight upon drying at 105° C. for 16 h. Protein was determined using a nitrogen analyzer commercially available as a Perkin Elmer Series II Nitrogen Analyzer, Model 2410, with a conversion factor from % nitrogen to % protein of 6.25. Starch was determined using an assay kit, which is commercially available as a Total Starch (AA/AMG Method) kit from Megazyme, Wicklow, Ireland. Total dietary bran was determined as the sum of neutral sugars, uronic acids, and lignin, according to AACC International Official Method 32-25 (28), except the procedure was modified to accommodate a smaller sample size (50 mg), and, because the starch content was known, the digestion procedure was skipped, and the glucose contributed by starch was subtracted from the total glucose content to obtain non-starch glucose. In preliminary experimentation, these modifications were found to give values for non-starch glucose and total dietary bran that were statistically indistinguishable from those using the method as published (data not shown). Each of these analyses was performed before and after in vitro upper-gastrointestinal digestion.

Additional characterization of the alkali-soluble fractions after in vitro upper-gastrointestinal digestion was performed using size-exclusion chromatography (SEC) and ¹H-NMR spectroscopy. For the chromatography, samples (2.0 mg/ml) were dissolved in 0.2% (w/v) sodium azide at 50° C. for 1 h, and filtered (5 μm cut-off). The filtered sample was injected onto a SEC system consisting of a pump commercially available from Varian in Walnut Creek, Calif., an injection valve commercially available from Rheodyne in Rohnert Park, Calif. with a 500 μL sample loop, a column (50 cm×2 cm) packed with Sephacryl S-500 commercially available from Amersham Biosciences in Piscataway, N.J. at room temperature, and a refractive index detector commercially available from Varian in Walnut Creek, Calif. Mobile phase was 0.2% sodium azide at 1.3 ml/min. Data were collected using Galaxie® software commercially available from Varian in Walnut Creek, Calif. Molecular weight was estimated using the retention times of known pullulan standards. Normalized peak areas were calculated by dividing the area of the peak of interest by the total area of all peaks.

Samples for ¹H-NMR spectroscopy were prepared by dissolving samples in deuterium oxide (10 mg/ml) for 8 h at room temperature, followed by freeze-drying. The dissolving and freeze-drying steps were repeated twice more, and then spectra were recorded on a 300 MHz spectrometer at 85° C. Sixty-four pulses were collected, with an acquisition time of 1.7 s, a relaxation delay of 2 s, and a pulse angle of 45°. Partial structural assignments of the peaks were made by comparison with previously published data (29-32).

For SCFA and branched chain fatty acid (BCFA) quantification, 0.4 ml of fermentation slurry was combined with 0.1 ml of 5% phosphoric acid (containing 50 mM 4-methyl valeric acid, as an internal standard), mixed with a vortex mixer, and allowed to rest for 30 min. Samples were then centrifuged at 13,000 rpm for 10 min, and a 4 μl aliquot was injected onto a HP 5890 GC equipped with a Nukol® capillary column, which is commercially available as 30 m×0.25 mm ID with 0.25 μm bonded phase from Supelco in Bellefonte, Pa., under conditions defined by the manufacturer.

Ammonia was determined using an enzymatic method known as the glutamate dehydrogenase/NADH/2-oxoglutarate method, which is commercially available from Boehringer in Mannheim, Germany, and residual carbohydrates (neutral sugars and uronic acids) were measured in freeze-dried fermentation residues using AACC International Official Method 32-25 (28) with the modifications described above (see Sample Analyses).

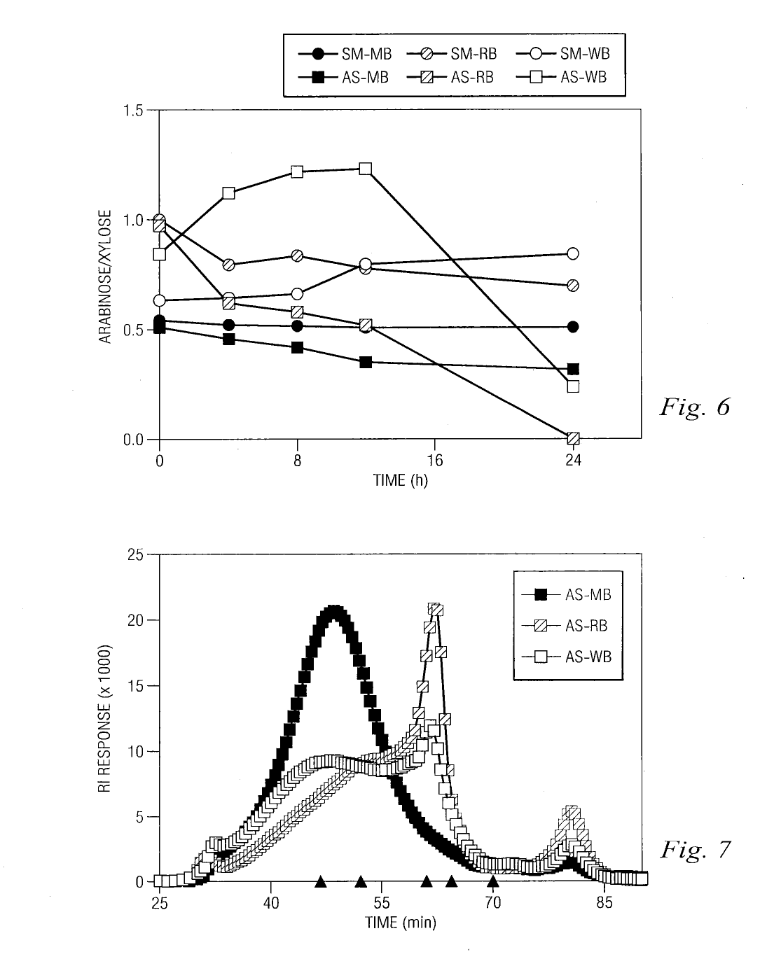

SAS software (version 9.1, SAS Institute, Cary, N.C.) was used to calculate statistical differences, which were defined as P<0.05. SCFA, see FIG. 4, and residual carbohydrate data, see FIG. 5, were analyzed using a mixed model analysis of variance (PROC MIXED) with Tukey's multiple comparison adjustment to determine differences between least-squares means between each sample at each time point during in vitro fermentation. Differences between metabolites [SCFAs, BCFAs, and ammonia] produced after 24 h of in vitro fermentation are shown in Table 3 and were analyzed using a general linear model analysis of variance (PROC GLM) with Fisher's least significant difference test used to determine differences between least-squares means. To determine significant trends for the change in arabinose/xylose ratio during in vitro fermentation, see FIG. 6, least-squares regression was used (PROC REG) using both linear (y=x) and polynomial (y=x²+x) models.

The combination of enzymatic and alkaline-hydrogen peroxide treatment was sufficient to remove at least 65% of the protein and 90% of the starch in the alkali-soluble fractions from corn, rice, and wheat brans, see Table 1. A higher percentage of the alkali-soluble fraction was found in corn bran compared to rice and wheat brans. The alkali-soluble fraction from corn bran was also the highest in total dietary bran and contained the least amount of non-starch glucose. The dietary bran composition of corn, rice, and wheat bran alkali-soluble fractions revealed that each contained mostly arabinoxylan, as these two monosaccharides (arabinose and xylose) represented the majority of neutral monosaccharides in the fractions.

TABLE 1
Composition (g/100 g of dm) of starting material (SM) and alkali-soluble (AS) fractions
prior to in vitro digestion.

| | Corn Bran | | Rice Bran | | Wheat Bran | |
|---|---|---|---|---|---|---|
| Constituent | SM | AS | SM | AS | SM | AS |
| Fraction of total | 100 | 38.3 ± 0.1^{a} | 100 | 13.1 ± 0.2 | 100 | 27.3 ± 0.1 |
| Protein^{b} | 4.75 ± 0.07 | 1.28 ± 0.11 | 19.5 ± 0.5 | 6.94 ± 0.25 | 19.3 ± 0.0 | 6.05 ± 0.13 |
| Starch | 9.66 ± 0.03 | ND^{c} | 29.8 ± 1.18 | 0.97 ± 0.07 | 14.4 ± 0.0 | 1.14 ± 0.28 |
| Total dietary | | | | | | |
| bran | 69.7 ± 1.8 | 61.5 ± 2.6 | 31.4 ± 0.9 | 38.1 ± 0.1 | 52.4 ± 0.2 | 62.7 ± 1.76 |
| Arabinose^{d} | 14.2 ± 0.6 | 17.0 ± 1.1 | 4.89 ± 0.08 | 14.2 ± 0.2 | 11.0 ± 0.1 | 26.0 ± 0.5 |
| Xylose | 27.3 ± 0.9 | 33.2 ± 1.5 | 4.38 ± 0.12 | 14.6 ± 0.1 | 16.2 ± 0.3 | 30.4 ± 0.7 |
| Mannose | 0.39 ± 0.03 | 0.16 ± 0.03 | 0.97 ± 0.00 | 0.17 ± 0.02 | 0.63 ± 0.02 | 0.10 ± 0.00 |
| Galactose | 4.33 ± 0.07 | 5.27 ± 0.11 | 1.21 ± 0.02 | 3.00 ± 0.01 | 1.38 ± 0.03 | 1.09 ± 0.04 |
| Glucose^{e} | 18.3 ± 0.5 | 0.93 ± 0.04 | 12.6 ± 0.7 | 1.68 ± 0.03 | 16.4 ± 0.0 | 1.76 ± 0.17 |
| Uronic | 2.59 ± 0.02 | 4.64 ± 0.00 | 1.16 ± 0.02 | 3.35 ± 0.04 | 1.27 ± 0.02 | 2.23 ± 0.03 |
| acids | | | | | | |
| Lignin | 2.63 ± 0.24 | 0.30 ± 0.14 | 6.10 ± 0.40 | 1.15 ± 0.16 | 5.59 ± 1.09 | 1.06 ± 0.33 |

^{a}Mean ± standard deviation; n = 2.
^{b}N × 6.25.
^{c}ND, none detected.
^{d}Expressed as anhydrous sugars.
^{e}Non-starch glucose.

The protein content of all samples remained roughly constant before, see Table 1, and after, see Table 2, in vitro digestion, indicating that the in vitro digestion procedure was ineffective at removing protein. The alkali-soluble fractions were extensively treated with protease during the extraction procedure prior to in vitro digestion, which may explain why these samples did not show a further decrease in protein during in vitro digestion; however, this does not explain why the bran starting materials did not decrease in protein content. Lebet et al. (25) described the difficulty in removing digestible components during in vitro digestion. The breakdown of digestible components was improved by increasing the levels of digestive enzymes used by a factor of 10 compared to the referenced method (25). The contaminating starch, not protein, has the greatest confounding effect on fermentation profiles. The enzymatic and alkaline-hydrogen peroxide treatment was able to remove most of the starch from all samples, see Table 2.

TABLE 2
Composition (g/100 g of dry matter) of starting material (SM) and alkali-soluble (AS)
fractions after in vitro digestion.

| | Corn Bran | | Rice Bran | | Wheat Bran | |
|---|---|---|---|---|---|---|
| Constituent | SM | AS | SM | AS | SM | AS |
| Protein^{a} | 4.40 ± 0.07^{b} | 2.30 ± 0.24 | 19.7 ± 0.5 | 9.34 ± 0.34 | 19.7 ± 0.5 | 7.60 ± 0.14 |
| Starch | 1.50 ± 0.02 | ND^{C} | 2.09 ± 0.11 | 0.42 ± 0.01 | 2.11 ± 0.02 | 0.26 ± 0.31 |
| Total dietary | | | | | | |
| Bran | 74.9 ± 0.4 | 69.3 ± 0.2 | 54.2 ± 0.3 | 51.2 ± 0.8 | 65.0 ± 0.6 | 71.7 ± 0.5 |
| Arabinose^{d} | 14.4 ± 0.2 | 19.2 ± 0.3 | 6.48 ± 0.02 | 19.2 ± 0.0 | 11.9 ± 0.5 | 28.7 ± 0.6 |
| Xylose | 28.0 ± 0.6 | 37.0 ± 0.1 | 6.05 ± 0.08 | 19.8 ± 0.3 | 17.9 ± 0.6 | 33.1 ± 0.2 |
| Mannose | 0.83 ± 0.05 | 2.78 ± 0.53 | 1.36 ± 0.00 | 0.55 ± 0.03 | 0.95 ± 0.03 | 0.57 ± 0.01 |
| Galactose | 4.93 ± 0.03 | 5.48 ± 0.01 | 1.82 ± 0.01 | 4.24 ± 0.12 | 1.29 ± 0.00 | 1.50 ± 0.10 |
| Glucose^{e} | 22.3 ± 0.2 | 0.69 ± 0.23 | 28.4 ± 0.2 | 1.86 ± 0.10 | 22.6 ± 1.4 | 1.27 ± 0.15 |
| Uronic | 2.95 ± 0.16 | 3.99 ± 0.33 | 1.74 ± 0.01 | 4.82 ± 0.10 | 1.68 ± 0.01 | 2.81 ± 0.08 |
| acids | | | | | | |
| Lignin | 1.50 ± 0.02 | 0.12 ± 0.00 | 8.39 ± 0.05 | 1.03 ± 0.08 | 8.66 ± 0.25 | 3.72 ± 0.04 |

^{a}N × 6.25.
^{b}Mean ± standard deviation; n = 2.
^{c}ND, none detected.
^{d}Expressed as anhydrous sugars.
^{e}Non-starch glucose.

The alkali-soluble fraction from corn bran produced significantly more SCFAs, which was calculated as the sum of acetate, propionate, and butyrate, than other samples tested, see Table 3. This indicates that the corn sample was highly fermentable, with efficient conversion of carbohydrate to SCFAs by the fecal bacteria. This fraction also displayed a much more linear shaped profile of SCFA production over the 24 h fermentation period compared to the other samples, see FIG. 1. Moreover, this fraction was the only sample to result in a significant increase in SCFAs during the second half of fermentation (p<0.001 for difference between SCFA production at 12 h vs. 24 h), indicating that this sample fermented slowly, as well as more extensively.

TABLE 3
SCFA and BCFA and ammonia expressed μmol/mg carbohydrate
as produced after 24 h of in vitro fecal fermentation^{a}.

| | Corn Bran | | Rice Bran | | Wheat Bran | |
|---|---|---|---|---|---|---|
| Metabolite | SM^{b} | AS | SM | AS | SM | AS |
| SCFA^{c} | 2.38^{D} | 19.6^{A} | 9.97^{C} | 14.2^{B} | 7.30^{C} | 9.93^{C} |
| Acetate | 1.70^{E} | 12.0^{A} | 6.59^{C} | 9.50^{B} | 4.71^{D} | 6.21^{CD} |
| Propionate | 0.185^{E} | 5.55^{A} | 1.41^{CD} | 2.77^{B} | 0.730^{ED} | 2.17^{BC} |
| Butyrate | 0.490^{C} | 2.02^{A} | 1.98^{A} | 1.99^{A} | 1.89^{AB} | 1.56^{B} |
| BCFA | ND | 0.290^{A} | 0.135^{B} | 0.075^{C} | 0.160^{B} | 0.135^{B} |
| Ammonia^{d} | 49.8^{C} | 9.93^{D} | 61.4^{B} | 12.3^{D} | 75.9^{A} | 8.02^{D} |

^{a}Means within row with different capital-letter superscripts are significantly different (p < 0.05); n = 2;
^{b}SM, starting material; AS, alkali-soluble; ND, none detected;
^{c}SCFA and BCFA expressed as μmol/mg carbohydrate with blank subtracted out of the data;
^{d}ammonia expressed as μmol/sample tube.

In vivo, a slow fermentation rate may be particularly beneficial (14). Once digesta reaches the distal colon, much of the fermentable carbohydrate has been fermented. Thus, the distal colon is chronically low in SCFAs, and exhibits higher levels of undesirable metabolites such as ammonia and phenol (13). A slowly fermentable dietary bran would help counter this gradient, and maintain more healthy colonic conditions in the distal colon.

The alkali-soluble fraction from corn bran was particularly propiogenic, producing significantly more of this SCFA after 24 h of fermentation than other samples, see Table 3. This is noteworthy because dietary brans that have high production of propionate may help reduce cholesterol (43). Among alkali-soluble fractions of the three brans, butyrate concentrations were approximately the same.

When fermentable carbohydrate is exhausted in the large intestine, bacteria begin to ferment protein as a source of energy. Bacterial fermentation of protein is commonly called putrefication, which results in a mixture of metabolites including hydrogen sulfide, phenolic, indolic, and N-nitroso compounds, BCFAs, amines, and ammonia (15). Some of these products are particularly undesirable. For instance, hydrogen sulfide blocks proper butyrate oxidation and utilization by the colonic epithelial cells and has been implicated in the pathogenesis of ulcerative colitis (48-49), phenol can react with nitrite (also present in the lumen of the colon) in vitro to produce the mutagenic compound p-diazoquinone (50), and ammonia induces histological damage to distal colonic mucosa (51).

BCFAs and ammonia were measured as markers of protein putrefication. The alkali-soluble fraction from corn bran produced more BCFAs, calculated as the sum of iso-butyrate and iso-valerate, than any other sample, see Table 3. Despite producing the highest level of BCFAs during fermentation, the alkali-soluble fraction from corn bran resulted in among the lowest of the test materials ammonia production during fermentation; alkali-soluble fractions resulted in low ammonia production during fermentation, while the bran starting materials produced higher levels, see Table 3.

The SCFA data revealed that the alkali-soluble fraction from corn bran fermented slowly and completely, while the alkali-soluble fractions from rice and wheat brans fermented more rapidly initially, suggesting that these brans were either incompletely fermented or the bacteria were less efficient at converting them to SCFAs. Thus, one would have expected the highest level of residual carbohydrate in the alkali-soluble fraction from corn bran at t=12 h, accompanied by the lowest level of carbohydrate in this sample at the final time (t=24 h). Instead, of the alkali-soluble fractions, the fraction from wheat bran showed the highest level of residual carbohydrate at both 8 and 12 h of fermentation, and all samples showed (nearly) complete fermentation after 24 h.

Because arabinoxylans consist, basically, of a xylose backbone with arabinose side chains (20), the arabinose to xylose ratio is a rough estimate of the degree of branching. FIG. 6 shows clear and substantial differences in change in arabinose to xylose ratios during the fermentation period among the three alkali-soluble arabinoxylans While the arabinose:xylose slope for the alkali-soluble fractions from both corn and rice alkali-soluble brans decreased significantly (p<0.05) over time, the alkali-soluble wheat bran arabinose to xylose ratio increased significantly (p<0.05) during the first 12 h fermentation and decreased during the second 12 h phase. These profiles for alkali-soluble corn and rice brans suggest a debranching mechanism of fermentation, wherein the bacteria hydrolyze the arabinose side chains off the xylan backbone at a faster rate than the xylan backbone is metabolized. This appears to hold true despite the large difference in the arabinose to xylose ratio between the corn bran and rice bran samples (0.50-0.54 for corn bran and 0.86-1.07 for rice bran), although there was a much more rapid initial decrease in arabinose to xylose ratio in the rice bran compared to the corn bran samples. For a debranching mechanism to occur first, it is likely that the branches would be (roughly) evenly distributed along the xylan backbone so that the latter is difficult to digest by xylanases. Perhaps for rice arabinoxylans, with higher arabinose content, initial higher fermentation rates could be attributed to longer arabinan branches being digested prior to the branch point. In contrast, the arabinoxylans found in wheat bran likely have irregularly spaced arabinose branches along the xylan backbone, such that there are large unsubstituted xylose regions that are easily hydrolyzed by bacterial xylanases and then rapidly ferment.

It is possible that the unbranched regions of wheat arabinoxylans are metabolized, the remaining oligosaccharides are quite densely branched, providing resistance to hydrolysis by bacterial arabinases due to steric hindrance. This would hinder fermentation, which as shown in FIG. 7, but eventually cause a decrease in the arabinose to xylose ratio as arabinases remove arabinose from the highly branched regions. This supposed situation would reflect the parabolic relationship observed for the arabinose to xylose ratio for the alkali-soluble fraction from wheat bran, see FIG. 6. This sample was the only one to show a significant squared term in the polynomial model (p=0.002), indicating curvature.

The alkali-soluble fraction from corn bran contained a less complex SEC profile than the fractions from rice and wheat brans with the former showing a single peak (normalized peak area, 98.5%) that crested at 49 min (˜500 kDa), see FIG. 4. Both the rice bran and wheat bran fractions showed a small peak (normalized peak areas, 1 and 3%, respectively) at 31 min. This represented the void volume of the column and was far too large to represent a single polymer, thus likely representing polymer aggregation. The chromatograms for the rice and wheat fractions were immediately followed by 2 large unresolved peaks. The first peak crested at 53 (˜200 kDa) and 49 min (˜500 kDa) for the rice and wheat fractions, respectively, and the second peak showed a maximum at 62 min (˜30 kDa) in both fractions. In the rice bran fraction, the peak area was nearly equally divided between the high and low molecular weight peaks, with normalized peak areas of 41 and 48%, respectively. The wheat bran fraction; however, contain a predominance of the higher molecular weight polymers (normalized peak area, 60%) compared to low molecular weight (normalized peak area, 33%). Both the rice and wheat bran fractions also showed a very low molecular weight peak at 81 min (˜600 Da), with normalized peak areas of 9 and 3%, respectively.

The finding that alkali-soluble rice and wheat arabinoxylans molecular weight distributions each showed two fractions may explain their surprisingly high initial productions of SCFAs, followed by a slower rate of production, see FIG. 4, with the lower molecular weight fraction perhaps fermenting more rapidly than the other.

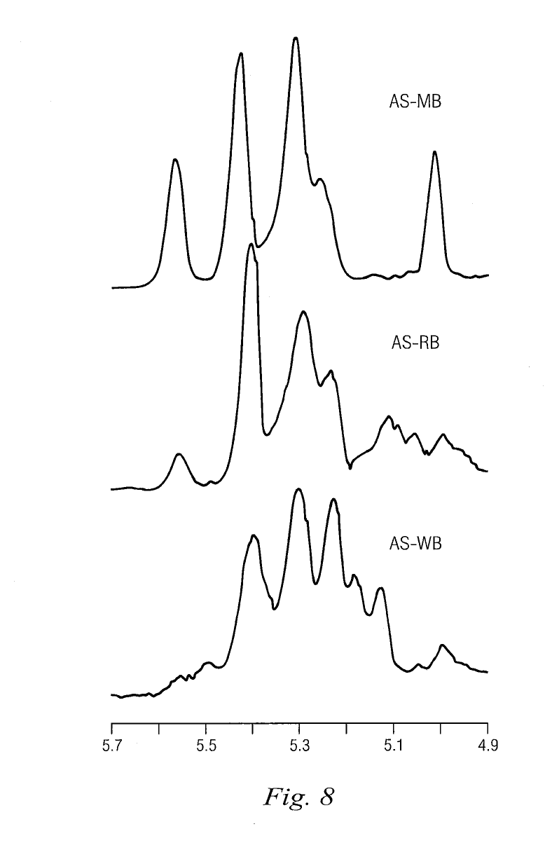

The portion of the ¹H-NMR spectrum for each of the alkali-soluble arabinoxylans where the anomeric protons of the α-linked arabinose units in an arabinoxylan resonate is shown in FIG. 8. The resonances at 5.40, 5.30, and 5.23 ppm present in all of the alkali-soluble fractions are characteristic of the anomeric protons of terminal arabinose units linked to main chain xylose residues. The resonance at 5.40 ppm represents the anomeric protons of Araf linked to O-3 of Xylp on the main chain (30-31). The two peaks at 5.30 and 5.23 ppm represent the anomeric protons of Araf linked to O-3 and O-2 of the same Xylp residue on the backbone (30-31). The peak at 5.30 ppm is larger than the peak at 5.23 ppm because the peak at 5.30 also represents the anomeric protons of Araf linked to O-2 of monosubstituted Xylp residues on the main chain (32).

Each spectrum contained additional resonances that may be attributed to the anomeric hydrogens of arabinose residues, including peaks between 5.00 and 5.20 and at 5.53 ppm. The resonance at 5.53, which is present in the alkali-soluble fractions from corn bran and rice bran, may be attributed to a disaccharide side chain with the structure: β-D-Xylp-(1→2)-α-L-Araf linked to 0-3 of Xylp on the main chain (29). For this side chain to be present, the ¹H-NMR spectrum must also show a resonance corresponding to the anomeric hydrogen of the Xylp residue, which occurs at 4.56 ppm (55). The alkali-soluble fraction from corn bran contained a clear resonance at this position, and, although the fraction from rice bran did not, it may have been buried under other peaks present in this region (data not shown). The alkali-soluble fraction from corn bran contained the highest proportion of this disaccharide side chain. The presence of this side chain, particularly if it were evenly distributed along the xylan backbone, may be a contributing factor to the slower fermentation rate of this sample, through the difficulty in hydrolyzing the unusual β(1-2) linkage.

Structural assignments for the resonances between 5.00 and 5.20 ppm were more difficult to define. Literature data suggest that these resonances represent substituted arabinose units (multi-unit branches or branched branches) (56-58). The peak at 5.00 ppm in particular has been shown in a number of previous reports (59-61), but has not been specifically identified. The peaks at 5.19 and 5.12 ppm, present in the alkali-soluble fraction from wheat bran, have also been previously found in rye bran after barium and potassium hydroxide extraction (60) and in barley after barium hydroxide extraction (62), but were not defined.

Because the ¹H-NMR spectra suggest that not all arabinose units are involved in single unit branches, the equations of Roels et al. (63) for calculating the distribution of un-, mono-, and disubstituted xylose residues on arabinoxylan, are not valid; however, from the quantitative integrals of the resonances at 5.40, 5.30, and 5.23, the ratio of monosubstituted to disubstituted xylose residues containing single-unit arabinose branches could be calculated. For the alkali-soluble fractions from corn, rice, and wheat brans, this ratio was 1.70, 1.44, and 0.85. This indicates that the alkali-soluble fraction from wheat bran contained a higher proportion of disubstituted xylose residues and, therefore more unsubstituted regions, which was expected from the parabolic relationship observed in arabinose to xylose ratio during fermentation, see FIG. 6. Additionally, this may explain why the alkali-soluble fraction from wheat bran was so poorly fermented during latter stages of fermentation (12-24 h); i.e., the disubstituted xylose residues were more difficult to digest.

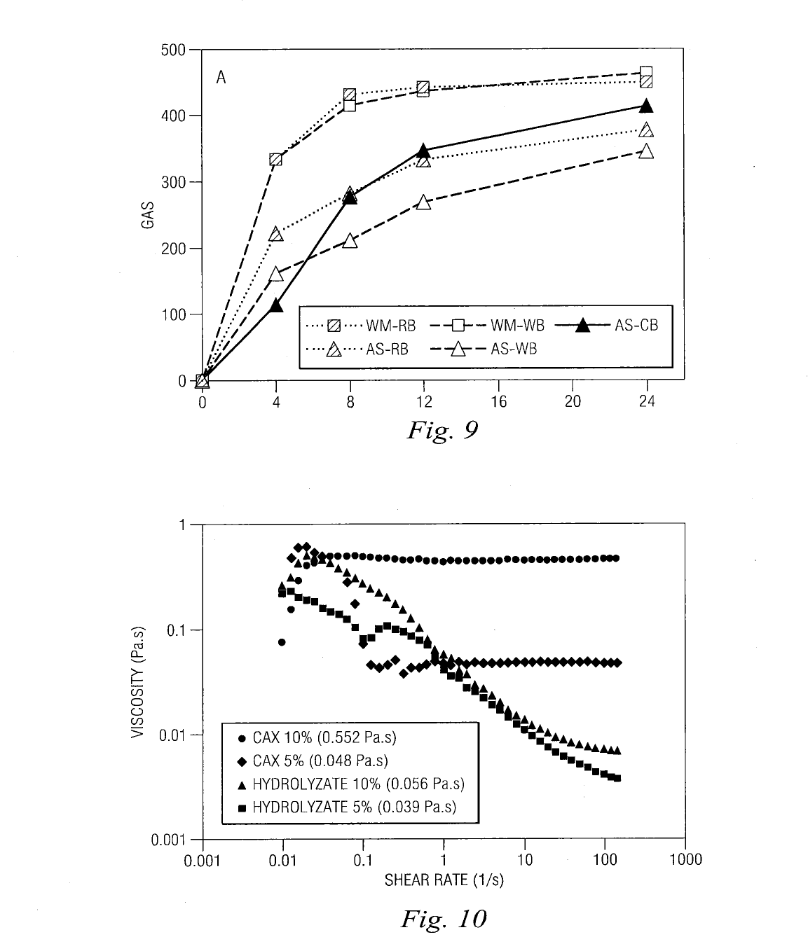

Gas production from in vitro fecal fermentation of water-soluble wheat and rice arabinoxylans and alkali-soluble corn, wheat and rice arabinoxylans is shown in FIG. 9. In the initial 4 hours of fermentation, alkali-soluble (treated) corn arabinoxylans produced a significantly lower amount of gas than the other untreated brans and the alkali-soluble wheat and rice arabinoxylans. The treated corn bran comprised of soluble corn arabinoxylan would likely produce less bloating when taken as a supplement or when incorporated in processed foods.

Moreover, the fermentation rate of the treated corn bran is linear with a high production of SCFAs during 24 h of in vitro fermentation. These unique characteristics are not present for the same from treated rice and wheat bran.

### Example 2

Finely ground corn bran was from Bunge Milling (St. Louis, Mo.), and heat-stabilized rice bran and wheat bran were obtained from a local market. Rice bran and wheat bran were finely ground in a cyclone mill to pass through a 0.8 mm screen. Bran was partially defatted with two volumes of hexane using a bran:hexane ratio of 1:7 weight/volume for 30 min in an Erlenmeyer flask. After stirring, the bran was allowed to settle for 5 to 10 minutes and the hexane was decanted through a vacuum flask, which collected the bran on Whatman No. 2 filter paper. The bran was allowed to air dry.

Bran was suspended in water in an amount of 1:9 w/w bran to water, and the pH was adjusted to 7.0. Under constant stirring, the mixture was boiled, and then cooled to 95° C. and 4 ml of heat stable α-amylase, which is commercially available from Sigma-Aldrich Corp., St. Louis, Mo., was added. The starch was hydrolyzed at about 90 to 95° C. for 30 min, and then the mixture was cooled in an ice bath to 50° C. The pH was adjusted to 6.0, and 5 ml of neutral protease, which is commercially available as Sigma P1236 protease from Bacillus amyloliquefaciens from Sigma-Aldrich Corp., St. Louis, Mo., were added. Protein was hydrolyzed at 50° C. for 4 h, and then the mixture was brought to a boil to inactivate enzymes, cooled in an ice bath, and the pH adjusted to 7.0. The slurry was centrifuged at 10,000 g for 10 minutes. The residue was washed 3 times with water, dried in a forced draft oven at 40° C. for 48 hours, ground in a cyclone mill, and passed through a 0.8 mm screen to yield enzyme treated bran fiber. These steps produced a destarched proteolyzed enzyme modified bran.

The enzyme modified bran then underwent an alkaline-hydrogen peroxide method (23-24), with modifications. Fifty grams of the enzyme-treated bran from above were suspended in 1 L of 1 M sodium hydroxide. Under constant mixing at 60° C., 42 ml of 30% hydrogen peroxide was slowly added to the mixture, which was stirred for a total of 4 h, and then centrifuged (10,000 g for 10 min), followed by the addition of 3 volumes of 95 ethanol to the supernatant. The mixture was held overnight at 4° C., and then the aqueous ethanol portion, containing the liberated ferulic acid, was siphoned off, discarded, and the precipitated material was washed with 80% ethanol, anhydrous ethanol, and acetone. The resulting powder was air dried until no solvent could be detected by odor, and then further dried in an oven at 40° C. for 24 h. The resulting residue was an alkali-soluble polysaccharide fraction isolated from the bran.

The alkali-soluble bran fraction then underwent a graded ethanol precipitation process, which involves rehydrating 30 grams of the alkali-soluble bran with 3% w/w water. Then 95% ethanol was added in an amount to achieve a concentration of 40% ethanol to the water and alkali-soluble bran mixture under continuous stirring for 30 minutes and kept in a refrigerator at 4° C. overnight. The mixture was then centrifuged for thirty minutes at 6° C., which provided a precipitate that was insoluble in 40% ethanol and a supernatant. Ethanol 95% was added to the supernatant to obtain a concentration of 60% ethanol by volume under continuous stirring for 30 minutes and was refrigerated overnight. The 60% ethanol mixture was then centrifuged at 10000×g for thirty minutes at 6° C. to yield a supernatant, which was discarded, and a precipitate that was insoluble in 60% ethanol. The ethanol was removed from the precipitate by air drying. The precipitate was rehydrated in deionized water and dried in a freeze drier, and was termed “corn arabinoxylan” or “CAX”. In case of alkali-soluble bran from wheat and rice, 95% ethanol was added in an amount to achieve a concentration of 90% ethanol to the water and alkali-soluble bran mixture under continuous stirring for 30 minutes and kept in a refrigerator at 4° C. overnight. The mixture was then centrifuged for thirty minutes at 6° C., which provided a precipitate that was insoluble in 90% ethanol and a supernatant which was discarded. The ethanol was removed from the precipitate by air drying. The precipitate was rehydrated in deionized water and dried in a freeze drier.

A hydrolyzate of the CAX fraction was prepared by the following endoxylanase treatment. Twenty-five grams of the CAX fraction was suspended in 1,250 ml of 25 mM sodium acetate buffer having a pH of about 5.0. Then 12.5 ml of endoxylanase an enzyme commercially available as Multifect® CX XL having an activity of 445×AU/ml from Genencor was added to the suspension, which was incubated in a shaking incubator at 55° C. for 26 hours. The enzyme suspension was then boiled for 30 minutes to inactivate the enzyme and centrifuged at 8000×g for thirty minutes. The small amount of precipitate was discarded to yield a hydrolyzate suspended in the supernatant. The supernatant was then dried in a freeze drier for 2 days at −60° C. to yield a hydrolyzate fraction.

After the endoxylanase treatment, the dried hydrolyzate fraction underwent a graded ethanol precipitation which involved rehydrating 10 grams of the hydrolyzate 3% w/w water. Then 95% ethanol was added in an amount to achieve a concentration of 40% ethanol to the water and hydrolyzate mixture under continuous stirring for 30 minutes and kept in a refrigerator at 4° C. overnight. The mixture was then centrifuged for thirty minutes at 6° C., which provided a precipitate that was insoluble in 40% ethanol and a supernatant. The precipitate was discarded. Ethanol 95% was added to the supernatant to obtain a concentration of 60% ethanol by volume under continuous stirring for 30 minutes and was refrigerated overnight. The 60% ethanol mixture was then centrifuged at 10000×g for thirty minutes at 6° C. to yield a supernatant and a precipitate, referred to as “grain 40-60%” and “hydrolyzate.” The supernatant was suspended in a concentration of ethanol up to 90% by volume by repeating the steps above to yield a fraction that is a precipitate insoluble in 90% ethanol by volume, referred to as “grain H 60-90%” and hydrolyzate. The corn hydrolyzate was referred to as “CH 40-60%” because it was precipitated between ethanol concentrations of 40% and 60%; the wheat hydrolyzate was referred to as “WH 40-60%” because it was precipitated between ethanol concentrations of 40% and 60%; and the rice hydrolyzate was referred to as “RH 60-90%” because it was precipitated with modified method between ethanol concentrations of 60% and 90%.

The CAX and hydrolyzate products of the corn bran were then tested, however, only the hydrolyzate product (not the CAX product) of wheat and rice bran were tested. Note that the tested samples are labelled CAX and hydrolyzate through the data and results section of this example. “CAX” in the testing and results section of this example is referring to the final CAX product after the graded ethanol precipitation and drying. The final hydrolyzate product after the graded ethanol precipitation and drying is referred to as the final corn hydrolyzate product as “CH 40-60%”, the final wheat hydrolyzate product was referred to as “WH 40-60%,” and the final rice hydrolyzate product was referred to as “RH 60-90%.”

In vitro digestion and fermentation involved the same methods as used in Example 1 except that phenol sulphuric method was used to determine the total carbohydrate in these samples. The fermentation analysis involved the same steps and procedures as in Example 1.

The viscosity of the CAX and hydrolyzate of the corn bran was tested using concentrations of 5% and 10% by volume of CAX or hydrolyzate in deionised water. The 5% or 10% mixture was boiled for 2 minutes and allowed to cool to room temperature. The viscosity was measured using a rotational rheometer, which is commercially available as AR-G2 from TA Instruments, Newcastle, Del. A 20 mm diameter parallel plate geometry was used with 500 gap. Shear rate was varied from 0.01 to 150 (1/s).

The data analysis used SAS software (version 9.2, SAS institute, Cary, N.C.) to calculate statistical differences, which were defined as P<0.05.

The sample composition prior to in vitro digestion is as follows:

TABLE 4
Composition (g/100 g of wet basis) of tested samples prior to in vitro digestion.

| | | | | | | Uronic |
|---|---|---|---|---|---|---|
| Sample | Arabinose | Xylose | Mannose | Galactose | Glucose | acid |
| CAX-Corn | 24.89 ± 1.83 | 47.25 ± 0.73 | 0.00 ± 0.00 | 6.96 ± 0.41 | 1.55 ± 0.14 | 4.06 ± 0.08 |
| CH 40-60% | 20.69 ± 0.73 | 45.07 ± 4.73 | 0.38 ± 0.11 | 9.63 ± 0.25 | 0.44 ± 0.05 | 3.94 ± 0.52 |
| WH 40-60% | 29.71 ± 0.93 | 26.04 ± 0.24 | 0.71 ± 0.05 | 1.72 ± 0.08 | 0.57 ± 0.12 | 3.17 ± 0.79 |
| RH 60-90% | 19.42 ± 2.82 | 20.82 ± 1.51 | 0.79 ± 0.02 | 2.90 ± 0.38 | 2.04 ± 0.30 | 3.88 ± 0.52 |

The SCFA and BCFA produced during in vitro fermentation are provided below in Table 5:

TABLE 5
SCFA and BCFA production as μmol/mg of sample.

| Metabolites | CAX | CH | WH | RH |
|---|---|---|---|---|
| Time (hours) | (Corn) | 40-60% | 40-60% | 60-90% |
| Acetate | | | | |
| 4 | 2.54^{D} | 2.06^{E} | 1.25^{F} | 5.77^{A} |
| 8 | 5.61^{C} | 5.62^{C} | 2.99^{E} | 7.62^{A} |
| 12 | 5.80^{C} | 6.26^{B} | 6.10^{BC} | 7.69^{A} |
| 24 | 6.38^{D} | 6.66^{CD} | 7.33^{B} | 7.82^{A} |
| Propionate | | | | |
| 4 | 0.0^{D} | 0.0^{D} | 0.29^{C} | 0.60^{B} |
| 8 | 1.44^{E} | 1.32^{E} | 1.62^{D} | 3.38^{A} |
| 12 | 3.75^{B} | 3.96^{B} | 3.81^{B} | 4.75^{A} |
| 24 | 4.41^{A} | 4.30^{A} | 4.40^{A} | 3.93^{A} |
| Butyrate | | | | |
| 4 | 0.62^{D} | 0.55^{D} | 0.47^{E} | 1.03^{C} |
| 8 | 0.67^{D} | 0.58^{E} | 0.33^{F} | 1.03^{C} |
| 12 | 0.73^{D} | 0.70^{D} | 0.66^{E} | 1.05^{C} |
| 24 | 0.80^{C} | 0.77^{C} | 0.92^{C} | 0.94^{C} |
| Total SCFA | | | | |
| 4 | 3.16^{C} | 2.61^{C} | 2.01^{D} | 7.39^{A} |
| 8 | 7.73^{D} | 7.51^{D} | 4.94^{E} | 12.03^{A} |
| 12 | 10.28^{D} | 10.93^{BC} | 10.57^{CD} | 13.49^{A} |
| 24 | 11.59^{A} | 11.73^{A} | 12.65^{A} | 12.69^{A} |
| BCFA | | | | |
| 4 | 0.0^{B} | 0.0^{B} | 0.01^{A} | 0.0^{B} |
| 8 | 0.02^{C} | 0.0^{D} | 0.0^{D} | 0.03^{B} |
| 12 | 0.08^{B} | 0.06^{C} | 0.02^{E} | 0.05^{D} |
| 24 | 0.13^{B} | 0.11^{C} | 0.13^{B} | 0.08^{D} |

*The same letters in a row mean that they are not significantly different (P > 0.05).

The total SCFA and BCFA after 24 hours are shown above in Table 5, the CAX and hydrolyzate end products produced by the methods described above show an increase in SCFAs as compared to untreated corn, wheat, and rice brans, see Table 3. The BCFAs rose in all treated samples, which indicates proteolysis.

The gas production from in vitro fermentation of the tested samples is provided in Table 6 below:

TABLE 6
Gas volume produced during 24 hour fermentation
in μl/mg of carbohydrate.

| | CAX | CH | WH | RH |
|---|---|---|---|---|
| Time (h) | (Corn) | 40-60% | 40-60% | 60-90% |
| 4 | 86^{B} | 66^{C} | 33^{D} | 188^{A} |
| 8 | 219^{BC} | 210^{C} | 121^{D} | 264^{A} |
| 12 | 265^{B} | 261^{BC} | 252^{C} | 286^{A} |
| 24 | 290^{C} | 301^{B} | 326^{A} | 298^{BC} |

*The same letters in a row mean that they are not significantly different (P > 0.05).

As shown in Table 6 and compared to FIG. 9, the treated CAX and hydrolyzate for corn and wheat had less gas production in the first four hours of fermentation as compared to the untreated corn and wheat. Moreover, the rice hydrolyzate produced a large amount of gas in the first four hours, which is undesirable because of related bloating problems, notably, abdominal distension and pain. The CAX, CH 40-60%, and WH 60-90% show low initial (first four hours) gas production, e.g. low initial gas production is gas production less than 90 μl/mg of carbohydrate over the first four hours of fermentation, yet showed overall high SCFA production indicating high fermentability in the later stages of fermentation.

FIG. 10 is a graph of viscosity of 5 and 10% CAX and the CH 40-60%, which shows a desirable shear-thinning effect of the hydrolyzate whereby viscosity is substantially reduced with in increased shear rate. At the higher concentration 10% concentration, the viscosity of the CH 40-60% hydrolyzate was substantially below CAX at shear rates higher than 1 s⁻¹.

The 5 and 10% CAX and CH 40-60% were observed for visual characteristics. The CH 40-60% hydrolyzate was lighter in color at both concentrations as compared to the CAX, which provides greater versatility for the use of CH 40-60% in a beverages or other liquids.

The foregoing description and embodiments are intended to illustrate the invention without limiting it thereby. It will be obvious to those skilled in the art that the invention described herein can be essentially duplicated by making minor changes in the material content or the method of manufacture. To the extent that such material or methods are substantially equivalent, it is intended that they be encompassed by the following claims.

### REFERENCES

(1) Agricultural Research Service. Nutrient intakes from food: Mean amounts consumed per individual, one day, 2005-2006; 2008; available at: http://www.ars.usda.gov/SP2UserFiles/Place/12355000/pdf/0506/Table_{—}1_NIF_{—}05.pdf; accessed on: 2 Oct. 2008.
(2) Food and Drug Administration. Attachment 8: Daily values for nutrition labeling. In: Guide to Nutrition Labeling and Education Act (NLEA) requirements; 1995; available at: http://www.fda.gov/ora/inspect_ref/igs/nleaatd.html#ATTACHMENT%208; accessed on: 2 October, 2008.
(3) Food and Nutrition Board. Dietary, functional, and total fiber. In Dietary Reference Intakes for Energy, Carbohydrate, Fiber, Fat, Fatty Acids, Cholesterol, Protein, and Amino Acids (Macronutrients); Institute of Medicine of the National Academies; National Academy Press: Washington, D.C., 2002; pp. 265-334.
(4) Lim, C. C.; Ferguson, L. R.; Tannock, G. W. Dietary fiber as “prebiotics”: Implications for colorectal cancer. Mol. Nutr. Food Res. 2005, 49, 609-619.
(5) Young, G. P.; Hu, Y.; Le Leu, R. K.; Nyskohus, L. Dietary fiber and colorectal cancer: A model for environment-gene interactions. Mol. Nutr. Food Res. 2005, 49, 571-584.
(6) Cameron-Smith, D.; Collier, G. R. Dietary fiber and glucose metabolism and diabetes. In: Handbook of Dietary Fiber; Cho, S. S., Dreher, M. L., Eds.; Marcel Dekker: New York, 2001; pp. 107-123.
(7) Brennan, C. S. Dietary fiber, glycaemic response, and diabetes. Mol. Nutr. Food Res. 2005, 49, 560-570.
(8) King, D. E. Dietary fiber, inflammation, and cardiovascular disease. Mol. Nutr. Food Res. 2005, 49, 594-600.
(9) Slavin, J. L. Dietary fiber and body weight. Nutrition 2005, 21, 411-418.
(10) Galvez, J.; Rodriguez-Cabezas, M. E.; Zarzuelo, A. Effects of dietary fiber on inflammatory bowel disease. Mol. Nutr. Food Res. 2005, 49, 601-608.
(11) Minino, A. M.; Heron, M. P.; Murphy, S. L.; Kochanek, K. D. Deaths: Final data for 2004. National Vital Statistics Reports 2007, 55, 8. Available at: http://www.cdc.gov/nchs/data/nvsr/nvsr55/nvsr55_{—}19.pdf; accessed on 2 Oct. 2008.
(12) Cummings, J. H.; Macfarlane, G. T. The control and consequences of bacterial fermentation in the human colon. J. Appl. Bacteriol. 1991, 70, 443-459.
(13) Macfarlane, G. T.; Gibson, G. R.; Cummings, J. H. Comparison of fermentation reactions in different regions of the human colon. J. Appl. Bacteriol. 1992, 72, 57-64.
(14) Rose, D. J.; Demeo, M. T.; Keshavarzian, A.; Hamaker, B. R. Influence of dietary fiber on inflammatory bowel disease and colon cancer and the importance of fermentation pattern. Nutrition Rev. 2007, 65, 51-62.
(15) Blachier, F.; Mariotti, F.; Huneau, J. F.; Tome, D.; Effects of amino acid-derived metabolites on the colonic epithelium and physiological consequences. Amino Acids 2007, 33, 547-562.
(16) Topping, D. Cereal complex carbohydrates and their contribution to human health. J. Cereal Sci. 2007, 46, 220-229.
(17) Cook, S. I.; Sellin, J. H.; Review article: Short chain fatty acids in health and disease. Aliment. Pharm. Therap. 1998, 12, 499-507.
(18) Glitso, L. V.; Jensen, B. B.; Knudsen, K. E. B. In vitro fermentation of rye carbohydrates including arabinoxylans of different structure. J. Sci. Food Agric. 2000, 80, 1211-1218.
(19) Karppinen, S.; Kiiliainen, K.; Liukkonen, K.; Forssell, P.; Poutanen, K. Extraction and in vitro fermentation of rye bran fractions. J. Cereal Sci. 2001, 34, 269-278.
(20) Izydorczyk, M. S.; Biliaderis, C. G. Cereal arabinoxylans. Advances in structure and physicochemical properties. Carbohydr. Polym. 1995, 28, 33-48.
(21) Bunzel, M.; Ralph, J.; Marita, J. M.; Hatfield, R. D.; Steinhart, H. Diferulates as structural components in soluble and insoluble cereal dietary fibre. J. Sci. Food Agric. 2001, 81, 653-660.
(22) Hopkins, M. J.; Englyst, H. N.; Macfarlane, S.; Furrie, E.; Macfarlane, G. T.; McBain, A. J. Degradation of cross-linked and non-cross-linked arabinoxylans by the intestinal microbiota in children. Appl. Environ. Microbiol. 2003, 69, 6354-6360.
(23) Doner, L. W.; Hicks, K. B. Isolation of hemicellulose from corn fiber by alkaline hydrogen peroxide extraction. Cereal Chem. 1997, 74, 176-181.
(24) Doner, L. W.; Chau, H. K.; Fishman, M. L.; Hicks, K. B. An improved process for isolation of corn fiber gum. Cereal Chem. 1998, 75, 408-411.
(25) Lebet, V.; Arrigoni, E.; Amado, R. Digestion procedure using mammalian enzymes to obtain substrates for in vitro fermentation studies. Lebensm. Wiss. Technol. 1998, 31, 509-515.
(26) Lebet, V.; Arrigoni, E.; Amado, R. Measurement of fermentation products and substrate disappearance during incubation of dietary fibre sources with human faecal flora. Lebensm. Wiss. Technol. 1998, 31, 473-479.
(27) Durand, M.; Dumay, C.; Beaumatin, P.; Morel, M. T. Use of the rumen simulation technique (RUSITEC) to compare microbial digestion of various by-products. Anim. Feed Sci. Tech. 1988, 21, 197-204.
(28) AACC International. Total dietary fiber—Determined as neutral sugar residues, uronic acid residues, and Klason lignin (Uppsala method). In: AACC International: Approved Methods of the American Association of Cereal Chemists, 10th ed.; AACC International Press: St. Paul, Minn., 2000; method 32-25.
(29) Kusakabe, I.; Ohgushi, S.; Yasui, T.; Kobayashi, T. Studies on the xylanase system of Streptomyces. 10. Structures of the arabinoxylo-oligosaccharides from the hydrolytic products of corncob arabinoxylan by a xylanase from Streptomyces. Agric. Biol. Chem. 1983, 47, 2713-2723.
(30) Hoffmann, R. A.; Geijtenbeek, T.; Kamerling, J. P.; Vliegenthart, J. F. G. ¹H-NMR study of enzymatically generated wheat-endosperm arabinoxylan oligosaccharides: structures of hepta- to tetradecasaccharides containing two or three branched xylose residues. Carbohydr. Res. 1992, 223, 19-44.
(31) Hoffmann, R. A.; Kamerling, J. P.; Vliegenthart, J. F. G. Structural features of a water-soluble arabinoxylan from the endosperm of wheat. Carbohydr. Res. 1992, 226, 303-11.
(32) Oscarsson, M.; Andersson, R.; Salomonsson A. C.; Aman, P. Chemical composition of barley samples focusing on dietary fibre components. J Cereal Sci. 1996, 24, 161-170.
(33) Cummings, J. H.; Christie, S.; Cole, T. J. A study of fructooligosaccharides in the prevention of travelers' diarrhea. Aliment. Pharm. Therap. 2001, 8, 1139-1145.
(34) Goldin, B R.; Gorbach, S. L.; The relationship between diet and rat fecal bacterial enzymes implicated in colon cancer. J. Natl. Cancer I. 1976, 57, 371-375.
(35) Thornton, J. R. High colonic pH promotes colorectal cancer. Lancet 1981, 1, 1081-1082.
(36) Scholz-Ahrens, K. E.; Ade, P.; Marten, B.; Weber, P.; Timm, W.; Asil, Y.; Gluer, C. C.; Schrezenmeir, J. Prebiotics, probiotics, and synbiotics affect mineral absorption, bone mineral content, and bone structure. J. Nutr. 2007, 137, S838-S846.
(37) Vince, A.; Killingley, M.; Wrong, O. M. Effect of lactulose on ammonia production in a fecal incubation system. Gastroenterology 1978, 74, 544-549.
(38) Fleming, S. E.; Choi, S. Y.; Fitch, M. D. Absorption of short-chain fatty acids from the rat cecum in vivo. J. Nutr. 1991, 121, 1787-1797.
(39) Wong, J. M. W.; de Souza, R.; Kendall, C. W. C.; Emam, A.; Jenkins, D. J. A. Colonic health: Fermentation and short chain fatty acids. J. Clin. Gastroenterol. 2006, 40, 235-243.
(40) Jenkins, D. J.; Wolever, T. M.; Jenkins, A.; Brighenti, F.; Vuksan, V.; Rao, A. V.; Cunnane, S. C.; Ocana, A.; Corey, P.; Vezina, C.; Connelly, P.; Buckley, G.; Patten, R. Specific types of colonic fermentation may raise low-density-lipoprotein-cholesterol concentrations. Am. J. Clin. Nutr. 1991, 54, 141-147.
(41) Wolever, T. M. S.; Spadafora, P.; Eshuis, H. Interaction between colonic acetate and propionate in humans. Am. J. Clin. Nutr. 1991, 53, 681-687.
(42) Hara, H.; Haga, S.; Kasai, T.; Kiriyama, S. Fermentation products of sugar beet fiber by cecal bacteria lower plasma cholesterol concentration in rats. J. Nutr. 1998, 128, 688-693.
(43) Cheng, H. H.; Lai, M. H. Fermentation of resistant rice starch produces propionate reducing serum and hepatic cholesterol in rats. J. Nutr. 2000, 130, 1991-1995.
(44) Roediger, W. E. Utilization of nutrients by isolated epithelial cells of the rat colon. Gastroenterology 1982, 83, 424-429.
(45) Scheppach, W.; Vartram, H. P.; Richter, F. Role of short-chain fatty acids in the prevention of colorectal cancer. Eur. J. Cancer 1995, 31A, 1077-1080.
(46) Ivan, M. S.; Rasoulpour, R. J.; Yin, L.; Hubbard, A. K.; Rosenberg, D. W.; Giardina, C. The luminal short-chain fatty acid butyrate modulates NF-κB activity in a human colonic epithelial cell line. Gastroenterology 2000, 118, 724-734.
(47) Luhrs, H.; Kudlich, T.; Neumann, M.; Schauber, J.; Melcher, R.; Gostner, A.; Scheppach, W.; Menzel, T. P. Butyrate-enhanced TNFalpha-induced apoptosis is associated with inhibition of NF-kappaB. Anticancer Res. 2002, 22, 1561-1568.
(48) Roediger, W. E. W.; Duncan, A.; Kapanaris, O.; Millard, S. Reducing sulfur compounds of the colon impair colonocyte nutrition: implications for ulcerative colitis. Gastroenterology 1993, 104, 802-809.
(49) Pitcher, M. C.; Pitcher, J. M. Hydrogen sulfide: a bacterial toxin in ulcerative colitis? Gut 1996, 39, 1-4.
(50) Kigugawa, K.; Kato, T. Formation of mutagenic diazoquinone by interaction of phenol with nitrite. Food Chem. Toxicol. 1988, 26, 209-214.
(51) Lin, H. C.; Visek, W. J. Colon mucosal cell damage by ammonia in rats. J Nutr. 1991, 121, 887-893.
(52) Schooneveld-Bergmans, M. E. F.; Beldman, G.; Voragen, A. G. J. Structural features of (glucurono)arabinoxylans extracted from wheat bran by barium hydroxide. J Cereal Sci. 1999, 29, 63-75.
(53) Salvador, V.; Cherbut, C.; Barry, J. L.; Bertrand, D.; Bonnet, C.; Delortlaval, J. Sugar composition of dietary fiber and short-chain fatty-acid production during in vitro fermentation by human bacteria. Br. J. Nutr. 1993, 70, 189-197.
(54) Gulfi, M.; Arrigoni, E.; Amado, R Influence of structure on in vitro fermentability of commercial pectins and partially hydrolysed pectin preparations. Carbohydr. Polym. 2005, 59, 247-255.
(55) Hoije, A.; Sandstrom, C.; Roubroeks, J. P.; Andersson, R.; Gohilb, S.; Gatenholm, P. Evidence of the presence of 2-O-β-D-xylopyranosyl-α-L-arabinofuranose side chains in barley husk arabinoxylan. Carbohydr. Res. 2006, 341, 2959-2966.
(56) Joseleau, J. P.; Chambat, G.; Vignon, M.; Barnoud, F. Chemical and ¹³C-NMR studies on two arabinans from the inner bark of young stems of Rosa glauca. Carbohydr. Res. 1997, 58, 165-175.
(57) Ebringerova, A.; Hromadkova, Z.; Alfoldi, J. Structural and solution properties of corn cob heteroxylans. Carbohydr. Polym. 1992, 19, 99-105.
(58) Cyran, M. R.; Saulnier, L. Association and structural diversity of hemicelluloses in the cell walls of rye outer layers: Comparison between two ryes with opposite breadmaking quality. J. Agric. Food Chem. 2007, 55, 2329-2341.
(59) Vinkx, C. J. A.; Stevens, I.; Gruppen, H.; Grobet, P. J.; Delcour, J. A. Physicochemical and functional-porperties of rye nonstarch polysaccharides 0.6. Variability in the structure of water-unextractable arabinoxylans. Cereal Chem. 1995, 72, 411-418.
(60) Nilsson, M.; Saulnier, L.; Andersson, R.; Aman, P. Water unextractable polysaccharides from three milling fractions of rye grain. Carbohydr. Polym. 1996, 30, 229-237.
(61) Verbruggen, M. A.; Spronk, B. A.; Schols, H. A.; Beldman, G.; Voragen, A. G. J.; Thomas, J. R.; Kamerling, J. P.; Vliegenthart, J. F. G. Structures of enzymically derived oligosaccharides from sorghum glucuronoarabinoxylan. Carbohydr. Res. 1998, 306, 265-274.
(62) Pitkanen, L.; Tuomainen, P.; Virkki, L.; Aseyev, V.; Tenkanen, M. Structural comparison of arabinoxylans from two barley side-stream fractions. J. Agric. Food Chem. 2008, 56, 5069-5077.
(63) Roels, S. P.; Collado, M.; Loosveld, A. M.; Grobet, P. J.; Delcour, J. A. Variation in the degree of D-xylose substitution in water-extractable European durum wheat (Triticum durum Desf.) semolina arabinoxylans. J. Agric. Food Chem. 1999, 47, 1813-1816.

What is claimed is:

1. A method for improving bowel health by increasing short chain fatty acid concentration in the colon of a mammal comprising:
administering to a mammal a composition having from about 0.1 grams to about 50 grams of a treated bran product produced from a method comprising:
(a) contacting a bran with a first alpha-amylase enzyme and a first protease enzyme sufficient to form an enzyme modified bran;
(b) deactivating said first alpha-amylase and protease enzymes;
(c) contacting said enzyme modified bran with an alkaline and hydrogen peroxide solution for a time sufficient to produce an alkali-soluble bran;
(d) isolating said alkali-soluble bran from said alkaline and hydrogen peroxide solution;
(e) contacting said alkali-soluble bran with a second alpha-amylase enzyme and a second protease enzyme sufficient to form a treated bran;
(f) deactivating said second alpha-amylase and protease enzymes; and
(g) isolating said treated bran from said second alpha-amylase and pro-tease enzymes to form a treated bran product;
wherein, after administration, said treated bran product results in an increased short chain fatty acid production during fermentation in the colon as compared to untreated bran fermented in the colon, and the carbohydrate content of said treated bran product is reduced more than untreated bran during fermentation.

2. The method according to claim 1,
wherein said bran comprises at least one bran selected from the group consisting of corn, wheat, rice, sorghum, and any combination thereof.

3. The method according to claim 2,
wherein, said treated bran product is made from corn bran and, after administration, said treated corn bran product produces a lower amount of gas during the first four hours of fermentation as compared to treated rice bran and wheat bran, wherein said treated rice bran and wheat bran are treated in the same manner as said treated corn bran.

4. The method according to claim 3,
wherein said treated corn bran product has a slow rate of fermentation.

5. The method according to claim 3,
wherein treated corn bran product is a fermentable substrate in the distal colon.

6. The method according to claim 3
wherein said treated corn bran product results in an increased short chain fatty acid production during fermentation in the colon as compared to treated rice bran and wheat bran.

7. The method according to claim 3,
wherein said treated corn bran product comprises from about 73% to about 93% by weight arabinoxylans.

8. The method according to claim 1,
wherein, during fermentation, the carbohydrate content is reduced to less than 10% of the initial carbohydrate content.

9. A method for improving bowel health by increasing short chain fatty acid concentration in the colon of a mammal comprising:
administering to a mammal a composition having from about 0.1 grams to about 50 grams of a treated bran product produced from a method comprising:
(a) contacting a bran with a first alpha-amylase enzyme and a first protease enzyme sufficient to form an enzyme modified bran;
(b) deactivating said first alpha-amylase and protease enzymes;
(c) contacting said enzyme modified bran with an alkaline and hydrogen peroxide solution for a time sufficient to produce an alkali-soluble bran;
(d) separating said alkali-soluble bran from said alkaline and hydrogen peroxide solution; and
(e) isolating said alkali-soluble bran using a first and a second precipitation step to produce a treated bran product, wherein said first ethanol precipitation step uses a first ethanol solution and said second ethanol precipitation step uses a second ethanol solution having an ethanol concentration higher than said first ethanol solution;
wherein, after administration, said treated bran results in an increased short chain fatty acid production during fermentation in the colon as compared to untreated bran fermented in the colon.

10. The method according to claim 9,
wherein said bran comprises at least one bran selected from the group consisting of corn, wheat, rice, sorghum, and any combination thereof.

11. The method according to claim 10,
wherein, said treated bran product is made from corn bran and, after administration, said treated corn bran product produces a low amount of gas during the first four hours of fermentation.

12. The method according to claim 11,
wherein said treated corn bran product comprises from about 50% to about 93% by weight arabinoxylans.

13. A method for improving bowel health by increasing short chain fatty acid concentration in the colon of a mammal comprising:
administering to a mammal a composition having from about 0.1 grams to about 50 grams of a bran hydrolyzate product produced from a method comprising:
(a) contacting a bran with a first alpha-amylase enzyme and a first protease enzyme sufficient to form an enzyme modified bran;
(b) deactivating said first alpha-amylase and protease enzymes;
(c) contacting said enzyme modified bran with an alkaline and hydrogen peroxide solution for a time sufficient to produce an alkali-soluble bran;
(d) separating said alkali-soluble bran from said alkaline and hydrogen peroxide solution;
(e) isolating said alkali-soluble bran using a first and a second precipitation step to produce an ethanol precipitated alkali-soluble bran, wherein said first ethanol precipitation step uses a first ethanol solution and said second ethanol precipitation step uses a second ethanol solution having an ethanol concentration higher than said first ethanol solution;
(f) contacting said ethanol precipitated alkali-soluble bran with an endoxylanase sufficient to form a bran hydrolyzate;
(g) deactivating said endoxylanase; and
(h) isolating said bran hydrolyzate using said first and second precipitation step to produce a bran hydrolyzate product;
wherein, after administration, said bran hydrolyzate product results in an increased short chain fatty acid production during fermentation in the colon as compared to untreated bran fermented in the colon.

14. The method according to claim 13,
wherein said bran comprises at least one bran selected from the group consisting of corn, wheat, rice, sorghum, and any combination thereof.

15. The method according to claim 14,
wherein, said bran hydrolyzate product is made from corn bran and, after administration, said corn bran hydrolyzate product produces a low amount of gas during the first four hours of fermentation as compared to rice bran hydrolyzate product.

16. The method according to claim 15,
wherein said corn bran hydrolyzate product comprises from about 50% to about 93% by weight arabinoxylans.

17. The method according to claim 14,
wherein, said bran hydrolyzate product is made from wheat bran and, after administration, said wheat bran hydrolyzate product produces a low amount of gas during the first four hours of fermentation as compared to a corn bran hydrolyzate product and a rice bran hydrolyzate product.

18. The method according to claim 17,
wherein said wheat bran hydrolyzate product comprises from about 50% to about 93% by weight arabinoxylans.

19. The method according to claim 13,
wherein a bran hydrolyzate product is made from corn and a bran hydrolyzate product is made from wheat and, the corn bran hydrolyzate product has a lower viscosity and a lighter color as compared to said wheat bran hydrolyzate product.
